(19) United States
(12) Patent Application Publication
(10) Pub. No.: US 2020/0413428 A1
(43) Pub. Date: Dec. 31, 2020

(54) TERMINAL APPARATUS, BASE STATION APPARATUS, AND COMMUNICATION METHOD

(71) Applicants: Sharp Kabushiki Kaisha, Sakai City, Osaka (JP); FG Innovation Company Limited, Tuen Mun, New Territories (HK)

(72) Inventors: Liqing LIU, Sakai City (JP); Shouichi SUZUKI, Sakai City (JP); Wataru OHUCHI, Sakai City (JP); Tomoki YOSHIMURA, Sakai City (JP); Taewoo LEE, Sakai City (JP)

(21) Appl. No.: 16/969,217

(22) PCT Filed: Feb. 14, 2019
(86) PCT No.: PCT/JP2019/005307

§ 371 Date: Aug. 12, 2020

(30) Foreign Application Priority Data
Feb. 14, 2018 (JP) 2018-023895

(51) Int. Cl. H04W 72/12; H04L 1/18; H04W 80/08; H04L 5/00; H04W 72/04

(52) U.S. Cl. CPC H04W 72/1268; H04L 1/1819; H04W 80/08; H04W 72/1284; H04W 72/0446; H04W 72/0413; H04L 5/0055

(57) ABSTRACT

A terminal apparatus includes: a receiver configured to receive higher layer signaling used for configuration of a HARQ-ACK PUCCH resource or a scheduling request PUCCH resource; and a transmitter configured to transmit a HARQ-ACK bit and a scheduling request bit, in which, in a case that the HARQ-ACK PUCCH resource overlaps with one or multiple scheduling request PUCCH resources in a time domain, a PUCCH format of the HARQ-ACK PUCCH resource for the HARQ-ACK transmission is a PUCCH format 1, and the scheduling request is a positive scheduling request, the HARQ-ACK bit is transmitted by using the PUCCH format 1 in the HARQ-ACK PUCCH resource, and a PUCCH format of the scheduling request PUCCH resource is a PUCCH format 0.

### TECHNICAL FIELD

The present invention relates to a terminal apparatus, a base station apparatus, and a communication method. This application claims the benefit of priority to Japanese Unexamined Patent Application No. 2018-023895 filed on Feb. 14, 2018, which is incorporated herein by reference in its entirety.

### BACKGROUND ART

A radio access method and a radio network for cellular mobile communication (hereinafter, referred to as “Long Term Evolution (LTE),” or “Evolved Universal Terrestrial Radio Access (E-UTRA)”) have been studied in the 3rd Generation Partnership Project (3GPP). In LTE, a base station apparatus is also referred to as an evolved NodeB (eNodeB), and a terminal apparatus is also referred to as user equipment (UE). LTE is a cellular communication system in which multiple areas are deployed in a cell structure, with each of the multiple areas being covered by a base station apparatus. A single base station apparatus may manage multiple cells.

3GPP has been studying a next generation standard (New Radio or NR) (NPL 1) to make a proposal for International Mobile Telecommunication (IMT)-2020, a standard for a next-generation mobile communication system, standardized by the International Telecommunication Union (ITU). NR is required to satisfy requirements for three scenarios including enhanced Mobile BroadBand (eMBB), massive Machine Type Communication (mMTC), and Ultra Reliable and Low Latency Communication (URLLC) in a single technology framework.

In NR, multiple scheduling request configurations have been studied (NPL 2). The multiple scheduling request configurations are configured for data of different services. Compared with the scheduling request configuration, the scheduling request is used for requesting a UL-SCH resource for initial transmission of data.

### CITATION LIST

### Non Patent Literature

NPL 1: “New SID proposal: Study on New Radio Access Technology,” RP-160671, NTT docomo, 3GPP TSG RAN Meeting #71, Goteborg, Sweden, 7th to 10th Mar., 2016.
NPL 2: “Scheduling request design in NR system,” R1-1713951, NTT docomo, Prague, Czech Republic, 21^{th} to 25^{th} Aug., 2017.

### SUMMARY OF INVENTION

### Technical Problem

However, a specific method for scheduling request bits and transmission corresponding to multiple scheduling request configurations has not been sufficiently studied.

An aspect of the present invention has been made in view of the point described above, and the present invention provides a terminal apparatus that can efficiently perform uplink and/or downlink communication, a communication method used for the terminal apparatus, an integrated circuit mounted on the terminal apparatus, a base station apparatus that can efficiently perform uplink and/or downlink communication, a communication method used for the base station apparatus, and an integrated circuit mounted on the base station apparatus.

### Solution to Problem

(1) According to a first aspect of the present invention, the following measure is provided. That is, the first aspect of the present invention is a terminal apparatus, the terminal apparatus including: a receiver configured to receive higher layer signaling used for configuration of a HARQ-ACK PUCCH resource or a scheduling request PUCCH resource; and a transmitter configured to transmit a HARQ-ACK bit and a scheduling request bit, in which, in a case that the HARQ-ACK PUCCH resource overlaps with one or multiple scheduling request PUCCH resources in a time domain, a PUCCH format of the HARQ-ACK PUCCH resource for the HARQ-ACK transmission is a PUCCH format 1, and the scheduling request is a positive scheduling request, the HARQ-ACK bit is transmitted by using the PUCCH format 1 in the HARQ-ACK PUCCH resource, and a PUCCH format of the scheduling request PUCCH resource is a PUCCH format 0.

(2) A second aspect of the present invention is a base station apparatus, the base station apparatus including: a transmitter configured to transmit higher layer signaling used for configuration of a HARQ-ACK PUCCH resource or a scheduling request PUCCH resource; and a receiver configured to receive a HARQ-ACK bit and a scheduling request bit, in which the HARQ-ACK PUCCH resource overlaps with one or multiple scheduling request PUCCH resources in a time domain, in a case that a PUCCH format of the HARQ-ACK PUCCH resource for the HARQ-ACK transmission is a PUCCH format 1, and the scheduling request is a positive scheduling request, the HARQ-ACK bit is received by using the PUCCH format 1 in the HARQ-ACK PUCCH resource, and a PUCCH format of the scheduling request PUCCH resource is a PUCCH format 0.

(3) A third aspect of the present invention is a communication method of a terminal apparatus, the communication method including the steps of: receiving higher layer signaling used for configuration of a HARQ-ACK PUCCH resource or a scheduling request PUCCH resource; and transmitting a HARQ-ACK bit and a scheduling request bit, in which the HARQ-ACK PUCCH resource overlaps with one or multiple scheduling request PUCCH resources in a time domain, in a case that a PUCCH format of the HARQ-ACK PUCCH resource for the HARQ-ACK transmission is a PUCCH format 1, and the scheduling request is a positive scheduling request, the HARQ-ACK bit is transmitted by using the PUCCH format 1 in the HARQ-ACK PUCCH resource, and a PUCCH format of the scheduling request PUCCH resource is a PUCCH format 0.

(4) A fourth aspect of the present invention is a communication method of a base station apparatus, the communication method including the steps of: transmitting higher layer signaling used for configuration of a HARQ-ACK PUCCH resource or a scheduling request PUCCH resource; and receiving a HARQ-ACK bit and a scheduling request bit, in which the HARQ-ACK PUCCH resource overlaps with one or multiple scheduling request PUCCH resources in a time domain, in a case that a PUCCH format of the HARQ-ACK PUCCH resource for the HARQ-ACK transmission is a PUCCH format 1, and the scheduling request is a positive scheduling request, the HARQ-ACK bit is received by using the PUCCH format 1 in the HARQ-ACK PUCCH resource, and a PUCCH format of the scheduling request PUCCH resource is a PUCCH format 0.

### Advantageous Effects of Invention

According to an aspect of the present invention, the terminal apparatus can efficiently perform uplink and/or downlink communication. Furthermore, the base station apparatus can efficiently perform uplink and/or downlink communication.

### BRIEF DESCRIPTION OF DRAWINGS

FIG. 1 is a conceptual diagram of a radio communication system according to the present embodiment.

FIG. 2 is an example illustrating a configuration of a radio frame, subframes, and slots according to an aspect of the present embodiment.

FIG. 3 is a diagram illustrating an example of a corresponding relationship between a logical channel and a scheduling request configuration according to the present embodiment.

FIG. 4 is a diagram illustrating an example of a configuration of the scheduling request configuration according to the present embodiment.

FIG. 5 is a flowchart for transmission of HARQ-ACK and/or transmission of a scheduling request bit according to the present embodiment.

FIG. 6 is a diagram illustrating an example in which a HARQ-ACK PUCCH resource and an SR PUCCH resource do not overlap with each other in a time domain, according to the present embodiment.

FIG. 7 is a diagram illustrating an example of determining a scheduling request bit size in a case that a HARQ-ACK PUCCH resource and an SR PUCCH resource overlap with each other in the time domain, according to the present embodiment.

FIG. 8 is a diagram illustrating an example of a mapping table between information of the scheduling request and a code point according to the present embodiment.

FIG. 9 is a diagram illustrating another example of determining a scheduling request bit size in a case that a HARQ-ACK PUCCH resource and an SR PUCCH resource overlap with each other in the time domain, according to the present embodiment.

FIG. 10 is a diagram illustrating another example of the mapping table between information of the scheduling request and the code point according to the present embodiment.

FIG. 11 is a diagram illustrating an example of mapping values of a HARQ-ACK bit or values of a HARQ-ACK bit and a positive scheduling request to sequences, according to the present embodiment.

FIG. 12 is a diagram illustrating an example of transmitting HARQ-ACK and a scheduling request using a PUCCH format 0, according to the present embodiment.

FIG. 13 is a diagram illustrating another example of transmitting HARQ-ACK and a scheduling request using the PUCCH format 0, according to the present embodiment.

FIG. 14 is a schematic block diagram illustrating a configuration of a terminal apparatus 1 according to the present embodiment.

FIG. 15 is a schematic block diagram illustrating a configuration of a base station apparatus 3 according to the present embodiment.

### DESCRIPTION OF EMBODIMENTS

Embodiments of the present invention will be described below. The expression “given” included in the following description may be construed as “determined” or “configured.”

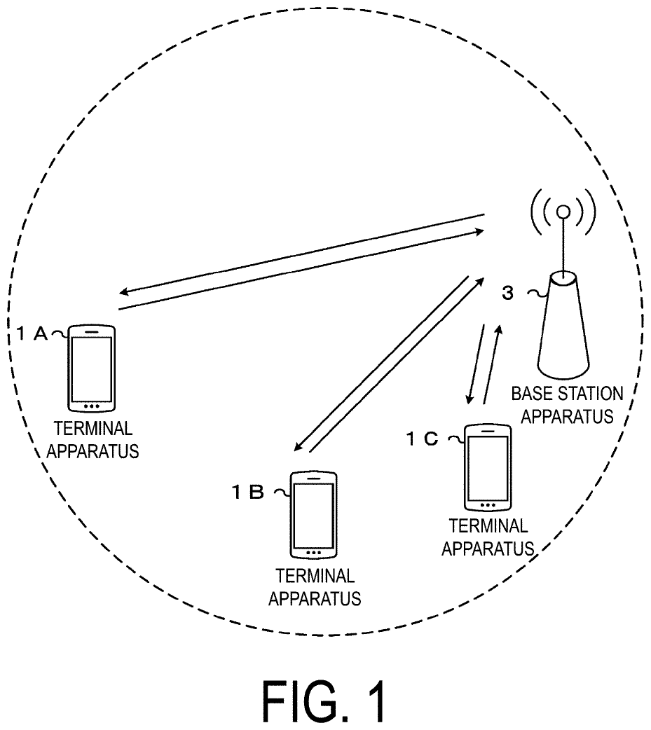

FIG. 1 is a conceptual diagram of a radio communication system according to the present embodiment. In FIG. 1, the radio communication system includes terminal apparatuses 1A to 1C and a base station apparatus 3. Hereinafter, the terminal apparatuses 1A to 1C are each also referred to as a terminal apparatus 1.

Hereinafter, carrier aggregation will be described.

According to the present embodiment, one or multiple serving cells are configured for the terminal apparatus 1. A technology that allows the terminal apparatus 1 to perform communication via the multiple serving cells is referred to as cell aggregation or carrier aggregation. The multiple serving cells may include one primary cell and one or multiple secondary cells. The primary cell is a serving cell in which an initial connection establishment procedure has been performed, a serving cell in which a connection re-establishment procedure has been initiated, or a cell indicated as a primary cell in a handover procedure. Here, the primary cell may be used for transmission on a PUCCH. The secondary cell may be configured at a point of time when or after a Radio Resource Control (RRC) connection is established.

A carrier corresponding to a serving cell in the downlink is referred to as a downlink component carrier. A carrier corresponding to a serving cell in the uplink is referred to as an uplink component carrier. A downlink component carrier and an uplink component carrier are collectively referred to as a component carrier.

The terminal apparatus 1 can perform simultaneous transmission and/or reception on multiple physical channels in multiple serving cells (component carriers). A single physical channel is transmitted in a single serving cell (component carrier) out of the multiple serving cells (component carriers).

Here, the base station apparatus 3 may configure one or multiple serving cells through higher layer signaling (e.g., RRC signaling, and RRC information). For example, one or multiple secondary cells may be configured to form a set of multiple serving cells with a primary cell. In the present embodiment, the carrier aggregation is applied to the terminal apparatus 1, unless specified otherwise. The terminal apparatus 1 performs channel transmission and/or reception in the multiple serving cells.

In the uplink for which the carrier aggregation is configured, one independent HARQ entity exists for each serving cell (uplink component carrier). In the uplink for which the carrier aggregation is configured, one independent HARQ entity exists in a MAC entity for each serving cell (uplink component carrier). The HARQ entity manages multiple HARQ processes in parallel. The HARQ process is associated with a HARQ buffer. In other words, the HARQ entity is associated with multiple HARQ buffers. The HARQ process stores data of a MAC layer in the HARQ buffer. The HARQ process indicates to a physical layer to transmit the data of the MAC layer.

The frame structure will now be described.

In the radio communication system according to an aspect of the present embodiment, at least Orthogonal Frequency Division Multiplexing (OFDM) is used. An OFDM symbol is a unit of the time domain for the OFDM. The OFDM symbol includes at least one or multiple subcarriers. The OFDM symbol is converted into a time-continuous signal in generation of a baseband signal.

With respect to Subcarrier Spacing (SCS), subcarrier spacing Δf=2^{μ}*15 kHz may be given. For example, for the subcarrier spacing configuration μ may be configured to any one of 0, 1, 2, 3, 4, and/or 5. For a Carrier bandwidth part (CBP), the subcarrier spacing configuration μ may be given as a parameter of a higher layer.

In the radio communication system according to an aspect of the present embodiment, a time unit T_{c} is used for representing a length of the time domain. The time unit T_{c} is given as T_{c}=1/(Δfₘₐₓ*Δfₘₐₓ may be the maximum value of the subcarrier spacing supported by the radio communication system according to an aspect of the present embodiment. Δfₘₐₓ may be Δfₘₐₓ=480 kHz. N_{f} may be N_{f}=4096. A constant κ is κ=Δfₘₐₓ*N_{f}/(Δf_{ref}N_{f,ref})=64. Δf_{ref} may be 15 kHz. N_{f}, ref may be 2048.

The constant κ may be a value indicating a relationship between reference subcarrier spacing and Tₑ. The constant κ may be used for a length of a subframe. The number of slots included in the subframe may be given at least based on the constant x. Δf_{ref} is the reference subcarrier spacing, and N_{f, ref} is a value corresponding to the reference subcarrier spacing.

Transmission in downlink and/or transmission in uplink is configured with frames each having a length of 10 ms. A frame is configured to include 10 subframes. A length of the subframe is 1 ms. The length of the frame may be given regardless of the subcarrier spacing Δf. That is, the frame may be given regardless of μ. The length of the subframe may be given regardless of the subcarrier spacing Δf. That is, the subframe may be given regardless of u.

For a certain subcarrier spacing configuration μ, the number and indices of slots included in a subframe may be given. For example, a first slot number n^{μ}ₛ, may be given in ascending order ranging from 0 to N^{subframe,μ}ₛₗₒₜ−1 in a subframe. For the subcarrier spacing configuration μ, the number and indices of slots included in a frame may be given. For example, a second slot number n^{μ}_{s, f} may be given in ascending order ranging from 0 to N^{frame, μ}ₛₗₒₜ−1 in a frame. N^{slot}_{symb} consecutive OFDM symbols may be included in one slot. N^{slot}_{symb} may be given at least based on part or all of a slot configuration and/or a Cyclic Prefix (CP) configuration. The slot configuration may be given by a higher layer parameter slot_configuration. The CP configuration may be given at least based on a higher layer parameter. The CP configuration may be given at least based on dedicated RRC signaling. Each of the first slot number and the second slot number is also referred to as a slot number (slot index).

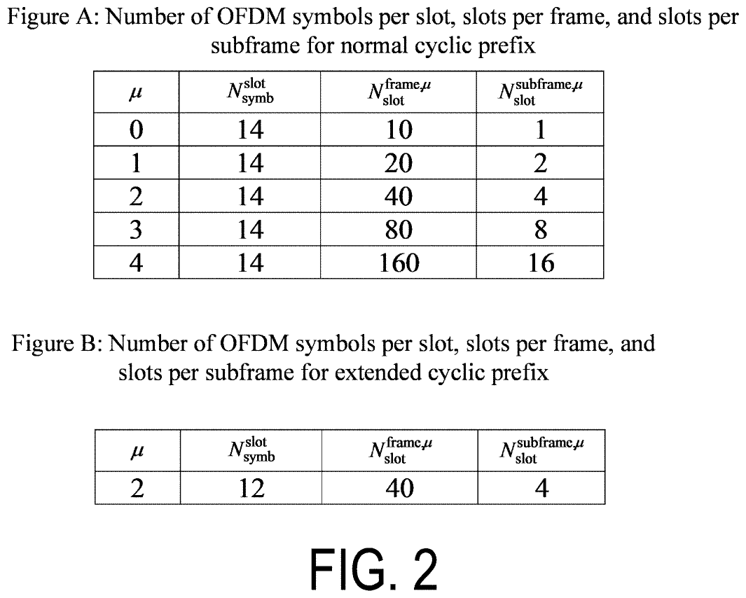

FIG. 2 is an example illustrating a relationship between N^{slot}_{symb}, the subcarrier spacing configuration μ, and the CP configuration according to an aspect of the present embodiment. In FIG. 2A, the number of OFDM symbols per slot may be 14 regardless of μ. In FIG. 2A, in a case that the subcarrier spacing configuration μ is 2 and the CP configuration is a normal cyclic prefix (normal CP), N^{slot}_{symb}=14, N^{frame,μ}ₛₗₒₜ=40, and N^{subframe, μ}ₛₗₒₜ=4. In addition, in FIG. 2B, in a case that the subcarrier spacing configuration μ is 2 and the CP configuration is an extended cyclic prefix (extended CP), N^{slot}_{symb}=12, N^{frame, μ}ₛₗₒₜ=40, and N^{subframe, μ}ₛₗₒₜ=4.

The OFDM symbol may be called a symbol. In addition, in a case that a communication scheme other than OFDM is used in communication between the terminal apparatus 1 and the base station apparatus 3 (e.g., in a case that SC-FDMA or DFT-s-OFDM is used, etc.), a SC-FDMA symbol and/or a DFT-s-OFDM symbol to be generated is also referred to as an OFDM symbol. In other words, the OFDM symbol may include the DFT-s-OFDM symbol and/or the SC-FDMA symbol. OFDM may include SC-FDMA or DFT-s-OFDM.

The OFDM includes a multi-carrier communication scheme in which waveform shaping (Pulse Shape), PAPR reduction, out-of-band radiation reduction, or filtering, and/or phase processing (e.g., phase rotation, etc.) are applied. The multi-carrier communication scheme may be a communication scheme for generating/transmitting a signal in which multiple subcarriers are multiplexed.

A physical channel and a physical signal according to various aspects of the present embodiment will be described below. The terminal apparatus may transmit the physical channel and/or the physical signal. The base station apparatus may transmit the physical channel and/or the physical signal.

Downlink physical channels and downlink physical signals are collectively referred to as downlink signals. Uplink physical channels and uplink physical signals are collectively referred to as uplink signals. Downlink physical channels and uplink physical channels are collectively referred to as physical channels. Downlink physical signals and uplink physical signals are collectively referred to as physical signals.

In uplink radio communication from the terminal apparatus 1 to the base station apparatus 3, the following uplink physical signals may be used. The uplink physical signals may not be used to transmit information output from a higher layer, but is used by a physical layer.
Uplink Reference Signal (UL RS)

According to the present embodiment, at least the following two types of uplink reference signal may be at least used.
Demodulation Reference Signal (DMRS)
Sounding Reference Signal (SRS)

The DMRS is associated with transmission of a PUSCH and/or a PUCCH. The DMRS may be multiplexed with the PUSCH or the PUCCH. The base station apparatus 3 uses the DMRS in order to perform channel compensation of the PUSCH or the PUCCH. Transmission of both of the PUSCH and the DMRS is hereinafter referred to simply as transmission of the PUSCH. The DMRS may correspond to the PUSCH. Transmission of both of the PUCCH and the DMRS is hereinafter referred to simply as transmission of the PUCCH. The DMRS may correspond to the PUCCH.

The SRS may not be associated with transmission of the PUSCH and/or the PUCCH. The SRS may be associated with transmission of the PUSCH and/or the PUCCH. The base station apparatus 3 may use the SRS for measuring a channel state. The SRS may be transmitted at the end of a subframe in an uplink slot or in a predetermined number of OFDM symbols from the end.

The following downlink physical channels may be used for downlink radio communication from the base station apparatus 3 to the terminal apparatuses 1. The downlink physical channels may be used by the physical layer to transmit information output from the higher layer.
Physical Broadcast CHannel (PBCH)
Physical Downlink Shared CHannel (PDSCH)
Physical Downlink Control CHannel (PDCCH)

The PBCH is used for broadcasting a master information block (MIB, BCH, or Broadcast Channel) that is commonly used by the terminal apparatuses 1. The PBCH may be transmitted at a prescribed transmission interval. For example, the PBCH may be transmitted at an interval of 80 ms. At least some of information included in the PBCH may be updated every 80 ms. The PBCH may include 288 subcarriers. The PBCH may include 2, 3, or 4 OFDM symbols. The MIB may include information on an identifier (index) of a synchronization signal. The MIB may include information indicating at least some of numbers of a slot, a subframe, and a radio frame in which a PBCH is transmitted. First configuration information may be included in the MIB. The first configuration information may be configuration information used at least in some or all of a random access message 2, a random access message 3, and a random access message 4.

The PDSCH is used to transmit downlink data (TB, MAC PDU, DL-SCH, PDSCH, CB, and CBG). The PDSCH is at least used to transmit a random access message 2 (random access response). The PDSCH is at least used to transmit system information including parameters used for initial access.

The PDCCH is used to transmit downlink control information (DCI). The downlink control information is also called a DCI format. The downlink control information may include at least either a downlink grant or an uplink grant. The downlink grant is also referred to as downlink assignment or downlink allocation. The uplink grant and the downlink grant are also collectively referred to as a grant.

A single downlink grant is at least used for scheduling of a single PDSCH in a single serving cell. The downlink grant may be used for at least scheduling of the PDSCH within the same slot as the slot in which the downlink grant has been transmitted.

A single uplink grant may be at least used for scheduling of a single PUSCH in a single serving cell.

For example, the downlink control information may include a New Data Indicator (NDI). The new data indicator may be used to at least indicate whether the transport block corresponding to the new data indicator is of initial transmission. The new data indicator may be information indicating whether a most recently transmitted transport block corresponding to a prescribed HARQ process number is the same as the transport block corresponding to the HARQ process number and included in the PDSCH and/or the PUSCH scheduled by the downlink control information including the new data indicator. The HARQ process number is a number used to identify the HARQ process. The HARQ process number may be included in the downlink control information. The HARQ process is a process for managing a HARQ. The new data indicator may indicate whether the transmission of the transport block corresponding to the prescribed HARQ process number and included in the PDSCH and/or the PUSCH scheduled by the downlink control information including the new data indicator is retransmission of the transport block corresponding to the prescribed HARQ process number and included in a most recently transmitted PDSCH and/or PUSCH. Whether the transmission of the transport block included in the PDSCH and/or the PUSCH scheduled by the downlink control information is retransmission of the most recently transmitted transport block may be given based on whether the new data indicator has been switched (or toggled) from a new data indicator corresponding to the most recently transmitted transport block.

That is, the new data indicator indicates initial transmission or retransmission. A HARQ entity of the terminal apparatuses 1 indicates to a certain HARQ process to trigger the initial transmission in a case that the new data indicator provided by the HARQ information has been toggled compared to the value of the new data indicator for a preceding transmission of the certain HARQ process. The HARQ entity indicates to the certain HARQ process to trigger retransmission in a case that the new data indicator provided by the HARQ information has not been toggled compared to the value of the new data indicator for the preceding transmission of the certain HARQ process. Note that whether the new data indicator has been toggled may be determined in the HARQ process.

In downlink radio communication, the following downlink physical signals may be used. The downlink physical signals may not be used for transmission of information output from the higher layer, but may be used by the physical layer.
Synchronization signal (SS)
Downlink Reference Signal (DL RS)

The synchronization signal is used for the terminal apparatus 1 to establish synchronization in a frequency domain and a time domain in the downlink. The synchronization signal includes at least a Primary Synchronization Signal (PSS) and a Secondary Synchronization Signal (SSS).

The synchronization signal including an ID of a target cell (cell ID) may be transmitted. The synchronization signal including a sequence generated at least based on the cell ID may be transmitted. The synchronization signal including the cell ID may means that the sequence of the synchronization signal is given based on the cell ID. The synchronization signal may be transmitted with application of a beam (or precoder).

The beam exhibits a phenomenon in which antenna gain varies depending on directions. The beam may be given at least based on the directivity of an antenna. In addition, the beam may also be given at least based on a phase transformation of a carrier signal. In addition, the beam may also be given by the application of the precoder.

The downlink reference signal is at least used for the terminal apparatus 1 to perform channel compensation of the downlink physical channel. The downlink reference signal is at least used for the terminal apparatus 1 to calculate channel state information of the downlink.

According to the present embodiment, the following two types of downlink reference signals are used.
DeModulation Reference Signal (DMRS)
Shared Reference Signal (Shared RS)

The DMRS corresponds to transmission of the PDCCH and/or the PDSCH. The DMRS is multiplexed with the PDCCH or the PDSCH. The terminal apparatuses 1 may use the DMRS corresponding to the PDCCH or the PDSCH in order to perform channel compensation of the PDCCH or the PDSCH. Hereinafter, transmission of both of the PDCCH and the DMRS corresponding to the PDCCH is simply referred to as transmission of the PDCCH. Hereinafter, transmission of both of the PDSCH and the DMRS corresponding to the PDSCH is simply referred to as transmission of the PDSCH.

The Shared RS may correspond to transmission of at least the PDCCH. The Shared RS may be multiplexed with the PDCCH. The terminal apparatuses 1 may use the Shared RS in order to perform channel compensation of the PDCCH. Hereinafter, transmission of both of the PDCCH and the Shared RS is also simply referred to as transmission of the PDCCH.

The DMRS may be an RS individually configured for the terminal apparatus 1. The sequence of the DMRS may be given at least based on parameters individually configured for the terminal apparatus 1. The DMRS may be individually transmitted for the PDCCH and/or the PDSCH. On the other hand, the Shared RS may be an RS commonly configured for multiple terminal apparatuses 1. The sequence of the Shared RS may be given regardless of the parameter individually configured for the terminal apparatus 1. For example, the sequence of the Shared RS may be given based on at least some of a slot number, a mini-slot number, and a cell identity (ID). The Shared RS may be an RS to be transmitted regardless of whether the PDCCH and/or the PDSCH has been transmitted.

The BCH, UL-SCH, and DL-SCH described above are transport channels. A channel used in a Medium Access Control (MAC) layer is referred to as a transport channel A unit of the transport channel used in the MAC layer is also referred to as a transport block or a MAC PDU. A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and a modulation process is performed for each codeword.

The base station apparatus 3 and the terminal apparatus 1 may exchange (transmit and/or receive) signals in the higher layer. For example, the base station apparatus 3 and the terminal apparatus 1 may transmit and/or receive Radio Resource Control (RRC) signaling (also referred to as a Radio Resource Control (RRC) message or Radio Resource Control (RRC) information) in an RRC layer. Furthermore, the base station apparatus 3 and the terminal apparatus 1 may transmit and/or receive, in the MAC layer, a MAC Control Element (CE). Here, the RRC signaling and/or the MAC CE is also referred to as higher layer signaling.

The PUSCH and the PDSCH are at least used to transmit the RRC signaling and the MAC CE. Here, the RRC signaling transmitted from the base station apparatus 3 on the PDSCH may be RRC signaling common to multiple terminal apparatuses 1 in a cell. The RRC signaling common to the multiple terminal apparatuses 1 in the cell is also referred to as common RRC signaling. The RRC signaling transmitted from the base station apparatus 3 on the PDSCH may be RRC signaling dedicated to a certain terminal apparatus 1 (which is also referred to as dedicated signaling or UE specific signaling). The RRC signaling dedicated to the terminal apparatus 1 is also referred to as dedicated RRC signaling. A cell specific parameter may be transmitted using the RRC signaling common to the multiple terminal apparatuses 1 in the cell or the RRC signaling dedicated to the certain terminal apparatus 1. A UE specific parameter may be transmitted using the RRC signaling dedicated to the certain terminal apparatus 1.

A Broadcast Control CHannel (BCCH), a Common Control CHannel (CCCH), and a Dedicated Control CHannel (DCCH) are logical channels. For example, the BCCH is a higher layer channel used to transmit the MIB. Additionally, the BCCH is the channel of the higher layer used to transmit system information. Note that the system information may include System Information Block type 1 (SIB1). Furthermore, the system information may also include a System Information (SI) message including System Information Block type 2 (SIB2). Furthermore, the Common Control Channel (CCCH) is a channel of the higher layer used to transmit information common to the multiple terminal apparatuses 1. Here, the CCCH is used for a terminal apparatus 1 that is not in an RRC connected state, for example. Furthermore, the Dedicated Control Channel (DCCH) is a channel of the higher layer used to transmit individual control information (dedicated control information) to the terminal apparatus 1. Here, the DCCH is used for a terminal apparatus 1 that is in the RRC connected state, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel is mapped to the PUSCH in the physical channel. The DL-SCH in the transport channel is mapped to the PDSCH in the physical channel. The BCH in the transport channel is mapped to the PBCH in the physical channel.

In uplink radio communication from the terminal apparatus 1 to the base station apparatus 3, at least the following uplink physical channels may be used. The uplink physical channels may be used by a physical layer for transmission of information output from a higher layer.
Physical Uplink Shared CHannel (PUSCH)
Physical Random Access CHannel (PRACH)
Physical Uplink Control CHannel (PUCCH)

The PUSCH is used to transmit uplink data (TB, MAC PDU, UL-SCH, PUSCH, CB, and CBG). The PUSCH may be used to transmit a HARQ-ACK and/or channel state information along with the uplink data. The PUSCH may be used to transmit only the channel state information or only the HARQ-ACK and the channel state information. The PUSCH is used to transmit a random access message 3.

The PRACH is used to transmit a random access preamble (random access message 1). The PRACH may be used to indicate at least some of an initial connection establishment procedure, a handover procedure, a connection re-establishment procedure, synchronization (timing adjustment) for transmission of uplink data, and a request for a PUSCH (UL-SCH) resource.

The PUCCH is used to transmit uplink control information (UCI). The uplink control information includes: Channel State Information (CSI) of a downlink channel; a Scheduling Request (SR) to be used to request a PUSCH (UpLink-Shared CHannel or UL-SCH) resource for initial transmission; and a Hybrid Automatic Repeat request ACKnowledgement (HARQ-ACK) for downlink data (a transport block or TB, a Medium Access Control Protocol Data Unit or MAC PDU, a DownLink-Shared CHannel or DL-SCH, a Physical Downlink Shared CHannel or PDSCH, a Code Block or CB, or a code block Group or CBG). The HARQ-ACK indicates an acknowledgement (ACK) or a negative-acknowledgement (NACK).

The HARQ-ACK is also referred to as an ACK/NACK, HARQ feedback, HARQ-ACK feedback, a HARQ response, a HARQ-ACK response, HARQ information, HARQ-ACK information, HARQ control information, and HARQ-ACK control information. In a case that downlink data is successfully decoded, an ACK for the downlink data is generated. In a case that the downlink data is not successfully decoded, a NACK for the downlink data is generated. Discontinuous transmission (DTX) may mean that the downlink data has not been detected. The discontinuous transmission (DTX) may mean that data for which a HARQ-ACK response is to be transmitted has not been detected. A PUCCH resource for HARQ-ACK is also referred to as a HARQ-ACK PUCCH resource.

The Channel State Information (CSI) may include a Channel Quality Indicator (CQI) and a Rank Indicator (RI). The channel quality indicator may include a Precoder Matrix Indicator (PMI). The channel state information may include a precoder matrix indicator. The CQI is an indicator associated with channel quality (propagation strength), and the PMI is an indicator indicating a precoder. The RI is an indicator indicating a transmission rank (or the number of transmission layers).

The scheduling request includes a positive scheduling request or a negative scheduling request. The positive scheduling request indicates that a UL-SCH resource for initial transmission is requested. The negative scheduling request indicates that the UL-SCH resource for the initial transmission is not requested. The terminal apparatus 1 may determine whether or not to transmit the positive scheduling request. The scheduling request being the negative scheduling request may mean that the terminal apparatus 1 has determined not to transmit the positive scheduling request. Note that the information of the scheduling request is information indicating, with respect to a certain scheduling request configuration, whether the scheduling request is a positive scheduling request or a negative scheduling request.

The base station apparatus 3 may configure multiple scheduling request configurations for the terminal apparatus 1 via higher layer signaling (RRC message, RRC information, RRC signaling, higher layer parameter). Note that the scheduling request configuration may include information (parameter) indicating a PUCCH resource for a scheduling request. The PUCCH resource for a scheduling request may also be referred to as an SR PUCCH resource. Information indicating a PUCCH resource for a scheduling request may include information indicating allocation of a frequency domain and information indicating allocation of a time domain to an SR PUCCH resource. The information indicating allocation of the frequency domain to the SR PUCCH resource may be information indicating a Physical Resource Block index (PRB index) to which the SR PUCCH resource is allocated. Furthermore, the information indicating the allocation of the time domain to the SR PUCCH resource may be information indicating an offset of a cycle and the time domain (subframe offset, slot offset, symbol offset). Note that the offset may be an offset in the time domain and may be an offset to the cycle. For example, the cycle may be defined by time, may be defined by the number of radio frames (in a radio frame unit), may be defined by the number of subframes (in a subframe unit), may be defined by the number of slots (in a slot unit), or may be defined by the number of OFDM symbols (in a symbol unit). Note that, the offset may be defined by time, may be defined by the number of radio frames (in a radio frame unit), may be defined by the number of subframes (in a subframe unit), may be defined by the number of slots (in a slot unit), or may be defined by the number of OFDM symbols (in a symbol unit). Note that the information indicating the allocation of the time domain to the SR PUCCH resource may be information indicating a transmission interval (time unit, transmission timing) of the SR PUCCH resource.

Based on a configuration of the higher layer parameter from the base station apparatus 3, the terminal apparatus 1 may transmit a scheduling request by PUCCH transmission using either a PUCCH format 0 or a PUCCH format 1. That is, the SR PUCCH resource may include a PUCCH format 0 resource and/or a PUCCH format 1 resource. The PUCCH format 0 and the PUCCH format 1 will be described later. The terminal apparatus 1 may transmit an SR using an SR PUCCH resource in a scheduling request transmission occasion. The scheduling request transmission occasion is defined by a slot and/or a symbol. The slot and the first OFDM symbol of the scheduling request transmission occasion may be given based on a configuration of a higher layer parameter. Transmitting the scheduling request by the SR PUCCH resource may mean transmitting a PUCCH for the scheduling request transmission occasion (SR transmission occasion, occasion for transmission of SR).

For a MAC entity, zero, one, or more scheduling request configurations may be configured. In other words, the base station apparatus 3 may configure multiple scheduling request configurations (Multiple SR configurations) for the terminal apparatus 1 using higher layer signaling. For each of the multiple scheduling request configurations, information indicating a PUCCH resource for a scheduling request may be independently (separately) configured. That is, for the scheduling request configurations, the SR PUCCH resources may be respectively configured. Each of the multiple scheduling request configurations may correspond to one or more than one logical channel Each of the logical channels may be mapped to one or multiple configurations among the multiple scheduling request configurations based on a higher layer signaling configuration. Which scheduling request configuration among the multiple scheduling request configurations is used may be given based on a logical channel that triggers the scheduling request. Note that triggering the scheduling request configuration may mean that the scheduling request is triggered for the scheduling request configuration. In a case that a scheduling request is triggered, the scheduling request is regarded to be pending until the scheduling request is canceled.

The logical channel may correspond to a data transfer service. For example, each of the multiple logical channels may support transfer of a specific type of information. That is, each logical channel type may be defined by which type of information is transferred.

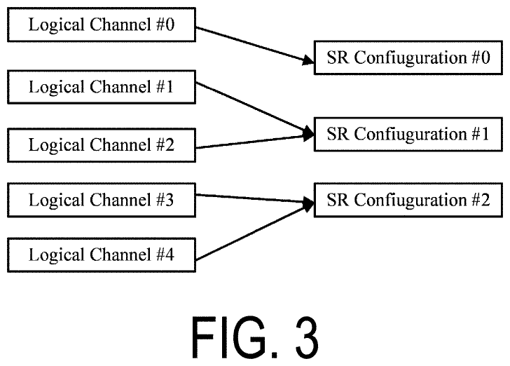

FIG. 3 is a diagram illustrating an example of a corresponding relationship between a logical channel and a scheduling request configuration according to the present embodiment. FIG. 3 illustrates a case that three scheduling request configurations are configured for the terminal apparatus 1. Each of the three scheduling request configurations corresponds to one or more than one logical channel. In FIG. 3, an SR configuration #0 may correspond to a logical channel #0. An SR configuration #1 may correspond to a logical channel #1 and a logical channel #2. An SR configuration #2 may correspond to a logical channel #3 and a logical channel 4. For example, in a case that a logical channel that triggers a scheduling request is the logical channel #0, the SR configuration #0 may be used. Furthermore, for example, in a case that a logical channel that triggers a scheduling request is the logical channel #3, the SR configuration #2 may be used. That is, whether any of the scheduling request configurations is used can be given based on the corresponding logical channel.

In a case that multiple scheduling request configurations are configured, transmission of one or multiple scheduling requests (SR PUCCH resources) occurs in a certain time unit.

The base station apparatus 3 may configure a priority among multiple scheduling request configurations for each of the multiple scheduling request configurations configured to the terminal apparatus 1, via higher layer signaling. The terminal apparatus 1 may perform, based on a priority configured by higher layer signaling, in a case that transmission of multiple scheduling requests occurs (is triggered) in a certain time unit, transmission of the scheduling request using an SR PUCCH resource for the scheduling request configuration with the highest priority.

The MAC layer may provide, to the physical layer, a notification/indication that which scheduling request configuration a scheduling request corresponding to is to be transmitted, based on a priority, for transmission of multiple scheduling requests occurring (triggered) in a certain time unit. In a case that the scheduling requests are simultaneously triggered for the respective multiple scheduling request configurations in the certain time unit, the priority of the scheduling request configuration may mean processing in which the MAC layer provides, to the physical layer, a notification/indication to signal a scheduling request for which scheduling request configuration. That is, in a case that the scheduling requests are simultaneously triggered for the respective multiple scheduling request configurations in the certain time unit, the MAC layer may select a scheduling request configuration with the highest priority among the multiple scheduling request configurations to each of which the triggered scheduling request corresponds, and provides, to the physical layer, a notification/indication to signal the scheduling request.

The priority of the scheduling request configuration may be linked to a priority of a logical channel corresponding to the scheduling request configuration. Furthermore, the priority of the scheduling request configuration may be given based on an index of the corresponding logical channel. For example, the priority of the scheduling request configuration corresponding to a small index among the corresponding logical channels may be high. Furthermore, for example, among scheduling request configurations for which the scheduling request is triggered, the priority of the scheduling request configuration in which the index of the logical channel that triggers the scheduling request is small may be high. Furthermore, the priorities of the multiple scheduling request configurations may be implicitly given based on the index of the scheduling request configuration. For example, the priority of the scheduling request configuration having a small value of the index may be made high, or the priority of the scheduling request configuration having a large/small value of the index may be made high. The priority of the scheduling request configuration may be linked to a type of transfer data corresponding to the logical channel. Furthermore, the priority of the scheduling request configuration may be given based on subcarrier spacing used for transmission of the data corresponding to the logical channel. For example, the priority of the logical channel in which a value of the subcarrier spacing corresponding to the logical channel is large (the subcarrier spacing is wide or the slot period is short) may be high. Furthermore, the priority of the scheduling request configuration may be given based on the number of OFDM symbols used for transmission of the data corresponding to the logical channel. For example, the priority of the logical channel in which the number of OFDM symbols used for transmission of the data is small (transmission time of the data is short) may be high. In other words, the terminal apparatus 1 can determine the priority of the scheduling request configuration based on the priority of the logical channel corresponding to the scheduling request configuration. Furthermore, the priority of the scheduling request configuration may be given based on the number of OFDM symbols of a PUCCH resource that is configured for the scheduling request configuration. For example, the priority of the scheduling request configuration in which the number of OFDM symbols of a PUCCH resource used for SR transmission is small may be high.

Furthermore, in a case that transmission of multiple scheduling requests to multiple scheduling request configurations is triggered in a certain time unit, the MAC layer may provide, to the physical layer, a notification/indication to signal the multiple scheduling requests. In this case, the terminal apparatus 1 may perform transmission of other PUCCH resources corresponding to the multiple scheduling requests instead of the SR PUCCH resources corresponding to the triggered multiple scheduling request configurations. The PUCCH resource may be configured via higher layer signaling beforehand. The PUCCH resource may be used to indicate information of a positive scheduling request to the triggered multiple scheduling request configurations. The PUCCH resource may be used to transmit a scheduling request bit field including multiple bits. The base station apparatus 3 may determine, based on detecting the transmission of the scheduling request in the PUCCH resource, that the multiple scheduling requests corresponding to the respective multiple scheduling request configurations are positive scheduling requests.

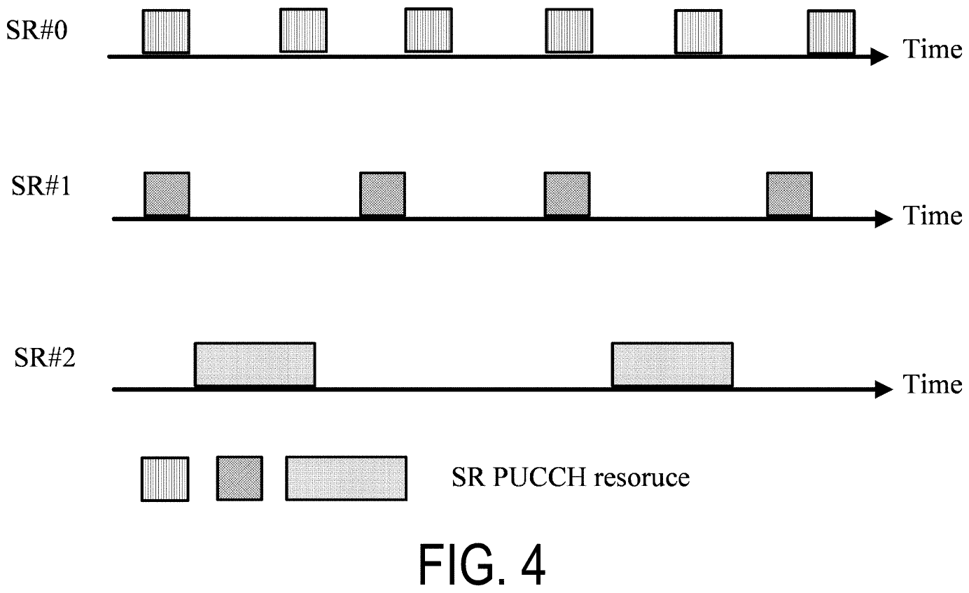

FIG. 4 is a diagram illustrating an example of a configuration of the scheduling request configuration according to the present embodiment. In FIG. 4, three scheduling request configurations are configured for the terminal apparatus 1. In FIG. 4, the three scheduling request configurations correspond to an SR #0, an SR #1, and an SR #2, respectively. Here, #0, #1, and #2 are indices of the scheduling request configurations. For example, the SR #0 with the minimum index may have the highest priority. The SR #2 with the maximum index may have the lowest priority. Each of the SR #0, the SR #1, and the SR #2 has a corresponding (associated) SR PUCCH resource. As illustrated in FIG. 4, a cycle, an offset, and/or the OFDM symbol of a PUCCH resource for a scheduling request for each of the SR #0, the SR #1, and the SR #2 may be differently configured. For example, in a case that a scheduling request is triggered for a certain scheduling request configuration, the terminal apparatus 1 may transmit the scheduling request by using an SR PUCCH resource that the scheduling request configuration has (corresponds to).

In the present embodiment, the terminal apparatus 1 configures a resource (PUCCH resource) for PUCCH transmission in a PUCCH format based on one or multiple higher layer signalings. A higher layer parameter PUCCH-resource-config-PF0 is used to configure one or multiple PUCCH resources for PUCCH transmission in a PUCCH format 0. A higher layer parameter PUCCH-resource-config-PF1 is used to configure one or multiple PUCCH resources for PUCCH transmission in a PUCCH format 1. A higher layer parameter PUCCH-resource-config-PF2 is used to configure one or multiple PUCCH resources for PUCCH transmission in a PUCCH format 2. A higher layer parameter PUCCH-resource-config-PF3 is used to configure one or multiple PUCCH resources for PUCCH transmission in a PUCCH format 3. A higher layer parameter PUCCH-resource-config-PF4 is used to configure one or multiple PUCCH resources for PUCCH transmission in a PUCCH format 4.

A format of the PUCCH according to the present embodiment will be described below.

At least five types of formats of the PUCCH may be given. The PUCCH format may be defined at least based on a value and type of a higher layer parameter used for configuration of a PUCCH resource corresponding to the PUCCH format, and/or the number of UCI bits that can be transmitted by the PUCCH resource corresponding to the PUCCH format. The PUCCH format is a name that includes some or all of the PUCCH format 0, the PUCCH format 1, the PUCCH format 2, the PUCCH format 3, and/or the PUCCH format 4.

The PUCCH format 0 is a format of the PUCCH by which UCI is transmitted by selection of a sequence. In the PUCCH format 0, a set of sequences for the PUCCH format 0 is defined. The set of sequences for the PUCCH format 0 includes one or multiple sequences for the PUCCH format 0. Among the one or multiple sequences for the PUCCH format 0, one sequence for the PUCCH format 0 is selected at least based on a block of bits. The selected sequence for the PUCCH format 0 is mapped to an uplink physical channel and transmitted. The block of bits may be given by the UCI. The block of bits may correspond to the UCI. In the PUCCH format 0, the number M_{bit} of bits of the block of bits may satisfy M_{bit}<3. In the PUCCH format 0, the number of OFDM symbols of the PUCCH may be one or two.

The selected sequence for the PUCCH format 0 may be multiplied by a prescribed power reduction factor (or amplitude reduction factor). The selected sequence for the PUCCH format 0 is mapped from a resource element (k, 1) for the PUCCH format 0 in ascending order with respect to k. The prescribed power reduction factor is at least used for transmission power control. Here, k is an index in the frequency domain. Furthermore, 1 is an index in the time domain.

That is, the PUCCH format 0 may be used to transmit the UCI including 1-bit or 2-bit HARQ-ACK and a scheduling request (in a case that it is present). The PUCCH format 0 may be used to transmit the UCI including a scheduling request. Information indicating a PUCCH resource used for the PUCCH format 0 may include information on an RB index and a cyclic shift. In other words, the difference in the PUCCH resource may mean that one of the RB index and the cyclic shift is different.

The PUCCH format 1 is a format of the PUCCH by which the UCI is transmitted by modulation of a sequence for the PUCCH format 1. The block of bits may be modulated with Binary Phase Shift Keying (BPSK) in a case that the number of bits included in the block of bits satisfies M_{bit}=1, and a complex-valued modulation symbol d(0) may be generated. The block of bits may be modulated with Quadrature Phase Shift Keying (QPSK) in a case that the number of bits included in the block of bits satisfies M_{bit}=2, and a complex-valued modulation symbol d(0) may be generated. In the PUCCH format 1, the number of bits of the block of bits may satisfy M_{bit}<3. In the PUCCH format 1, the number of OFDM symbols of the PUCCH may be equal to or greater than four.

That is, the PUCCH format 1 may be used to transmit the UCI including 1-bit or 2-bit HARQ-ACK, and/or a scheduling request (in a case that it is present). The PUCCH format 1 may be used to transmit the UCI including a scheduling request.

In a case that the terminal apparatus 1 transmits the HARQ-ACK using the PUCCH format 1, in a case that a HARQ-ACK PUCCH resource on which the transmission of the PUCCH format 1 is performed and one or multiple SR PUCCH resources overlap with each other in the time domain, in a case that the scheduling request is a negative scheduling request for each scheduling request configuration having the SR PUCCH resource that has overlapped, the terminal apparatus 1 transmits the HARQ-ACK using the PUCCH resource for the HARQ-ACK.

In a case that the terminal apparatus 1 transmits the HARQ-ACK using the PUCCH format 1, in a case that a HARQ-ACK PUCCH resource on which the transmission of the PUCCH format 1 is performed and one or multiple SR PUCCH resources overlap with each other in the time domain, in a case of a positive scheduling request for a scheduling request configuration having the SR PUCCH resource that has overlapped, the terminal apparatus 1 transmits the HARQ-ACK using the PUCCH resource for the scheduling request. The base station apparatus 3 identifies for which scheduling request configuration a scheduling request has been transmitted based on by which SR PUCCH resource the HARQ-ACK having been detected. Here, in a case that there are multiple scheduling request configurations for the positive scheduling request, the terminal apparatus 1 may transmit the HARQ-ACK using an SR PUCCH resource corresponding to a scheduling request configuration with the highest priority therein.

In the present embodiment, whether or not a first PUCCH resource overlaps or partially overlaps with a second PUCCH resource in the time domain may be given at least based on those described below.
The first symbol of each of the first PUCCH resource and the second PUCCH resource
The last symbol of each of the first PUCCH resource and the second PUCCH resource
A length of a symbol of each of the first PUCCH resource and the second PUCCH resource
A PUCCH format of each of the first PUCCH resource and the second PUCCH resource
UCI (HARQ-ACK, SR) transmitted by each of the first PUCCH resource and the second PUCCH resource

In the present embodiment, the overlapping of the first PUCCH resource with the second PUCCH resource in the time domain may mean that the first symbol of the first PUCCH resource is the same as the first symbol of the second PUCCH resource. In the present embodiment, the overlapping of the first PUCCH resource with the second PUCCH resource in the time domain may mean that the first symbol of the first PUCCH resource is the same as the first symbol of the second PUCCH resource, and that the length (duration) of the symbol of the first PUCCH resource is the same as the length of the symbol of the second PUCCH resource. For example, for the terminal apparatus 1, the overlapping of the SR PUCCH resource with the HARQ-ACK PUCCH resource in the time domain may mean that the first symbol of a scheduling request transmission occasion (SR transmission occasion, occasion for transmission of SR) in the PUCCH used for transmission of SR is the same as the first symbol of the HARQ-ACK transmission. For example, for the terminal apparatus 1, the overlapping of the SR PUCCH resource with the HARQ-ACK PUCCH resource in the time domain may mean that the first symbol of the scheduling request transmission occasion in the PUCCH used for transmission of SR is the same as the first symbol of the HARQ-ACK transmission, and that the symbol length of the scheduling request transmission occasion in the PUCCH used for transmission of SR is the same as the symbol length (duration) of the HARQ-ACK transmission.

Furthermore, in the present embodiment, the partially overlapping of the first PUCCH resource with the second PUCCH resource in the time domain may at least include one or multiple cases of cases 1 to 3 described below.

(Case 1) The first symbol of the first PUCCH resource is the same as the first symbol of the second PUCCH resource, and the length (duration) of the symbol of the first PUCCH resource is different from the length of the symbol of the second PUCCH resource.

(Case 2) At least one OFDM symbol of the first PUCCH resource overlaps with any symbol of the second PUCCH resource. Here, the first symbol of the first PUCCH resource may be the same as or may be different from the first symbol of the second PUCCH resource.

(Case 3) At least one symbol of the first PUCCH resource overlaps with any symbol of the second PUCCH resource, and a difference between the first symbol of the first PUCCH resource and the first symbol of the second PUCCH resource is less than a threshold.

Here, the threshold may be given at least based on the PUCCH format of each of the first PUCCH resource and the second PUCCH resource and/or the UCI (HARQ-ACK, SR) transmitted on each of the first PUCCH resource and the second PUCCH resource.

Hereinafter, in the present embodiment, the overlapping of the SR PUCCH resource with the HARQ-ACK PUCCH resource in the time domain may include that the SR PUCCH resource partially overlaps with the HARQ-ACK PUCCH resource in the time domain.

In the present embodiment, the terminal apparatus 1 may perform transmission of the PUCCH format 0 or the PUCCH format 1 in the SR PUCCH resource.

The PUCCH format 2 is a format of the PUCCH by which the UCI is transmitted by modulation of a sequence for the PUCCH format 2. In a block of bits, for example, based on the modulation, an output sequence z^{(p)} (n) for the PUCCH format 2 may be generated. In the PUCCH format 2, the number of bits of the block of bits may satisfy M_{bit}>2. In the PUCCH format 2, the number of OFDM symbols of the PUCCH may be one or two.

The PUCCH format 3 is a format of the PUCCH by which the UCI is transmitted by modulation of a sequence for the PUCCH format 3. In a block of bits, for example, based on the modulation, an output sequence z^{(p)} (n) for the PUCCH format 3 may be generated. In the PUCCH format 3, the number of bits of the block of bits may satisfy M_{bit}>2. In the PUCCH format 3, the number of OFDM symbols of the PUCCH may be equal to or greater than four.

The PUCCH format 4 is a format of the PUCCH by which the UCI is transmitted by modulation of a sequence for the PUCCH format 4. In a block of bits, for example, based on the modulation, an output sequence z^{(p)} (n) for the PUCCH format 3 may be generated. In the PUCCH format 4, the number of bits of the block of bits may satisfy M_{bit}>2. In the PUCCH format 3, the number of OFDM symbols of the PUCCH may be equal to or greater than four. The number of bits for the PUCCH format 4 may be less than the number of bits for the PUCCH format 3. For example, the number of bits for the PUCCH format 4 may be limited so as not to exceed a prescribed value.

That is, the PUCCH format 2, the PUCCH format 3, and the PUCCH format 4 are used to transmit the UCI including the HARQ-ACK of more than two bits, a scheduling request (in a case that it is present), and/or CSI (in a case that it is present). That is, the UCI is formed with the number of bits greater than two bits.

In the present embodiment, the terminal apparatus 1 may not perform transmission of the PUCCH format 2, the PUCCH format 3, or the PUCCH format 4 in the SR PUCCH resource.

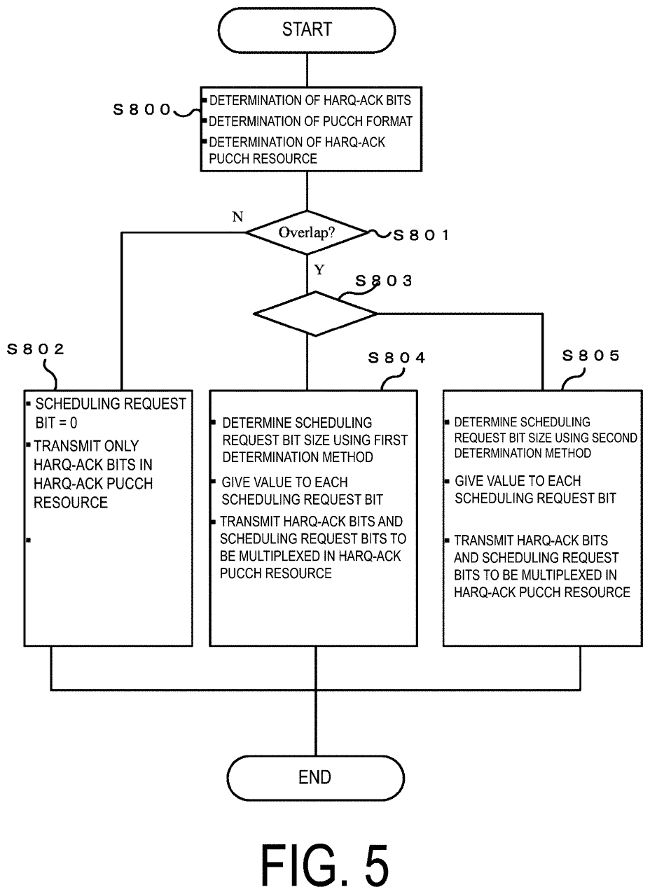

Transmission of the HARQ-ACK and/or the scheduling request in a certain slot according to the present embodiment will be described below. FIG. 5 is a flowchart for transmission of HARQ-ACK and/or transmission of a scheduling request bit according to the present embodiment.

(S800) The terminal apparatus 1 may determine (generate) HARQ-ACK bits for received downlink data (PDSCH). Note that the terminal apparatus 1 may set ACK or NACK to each of the HARQ-ACK bits based on a decoding result of the downlink data. Next, the terminal apparatus 1 may determine a PUCCH format and a HARQ-ACK PUCCH resource for transmission of the HARQ-ACK at least based on higher layer signaling and/or a downlink grant. For example, the terminal apparatus 1 may determine any one of the PUCCH format 2, the PUCCH format 3, and the PUCCH format 4. Hereinafter, in the present embodiment, the HARQ-ACK PUCCH resource may be used for transmission of any one of the PUCCH format 2, the PUCCH format 3, and the PUCCH format 4.

(S801) The terminal apparatus 1 may determine that which step is then selected for proceeding based on a first condition. The first condition is a condition whether or not the HARQ-ACK PUCCH resource used for transmission of the HARQ-ACK overlaps with an SR PUCCH resource in the time domain. Here, the HARQ-ACK PUCCH may be the resource determined in (S800). In other words, the terminal apparatus 1 proceeds to S802 in a case that the HARQ-ACK PUCCH resource and the SR PUCCH resource do not overlap with each other. The terminal apparatus 1 proceeds to S803 in a case that the HARQ-ACK PUCCH resource and the SR PUCCH resource overlap with each other.

(S802) The terminal apparatus 1 determines a scheduling request bit O^{SR} size as 0, and transmits the HARQ-ACK bits in the HARQ-ACK PUCCH resource.

(S803) The terminal apparatus 1 selects a first determination method or a second determination method based on a second condition. Here, (S804) corresponds to the first determination method. Furthermore, (S805) corresponds to the second determination method. The second condition may be higher layer signaling. The higher layer signaling is used to indicate whether or not to utilize any of the first determination method and the second determination method. The first determination method and the second determination method will be described later.

Furthermore, the second condition is a type of the PUCCH format used to transmit the HARQ-ACK. In other words, whether or not any of the determination methods is used is given in accordance with the type of the PUCCH format. As one example, in a case that the HARQ-ACK is transmitted by using the PUCCH format 2 or 3, for example, the terminal apparatus 1 may select the first determination method (S804). In a case that the HARQ-ACK is transmitted by using the PUCCH format 4, the terminal apparatus 1 may select the second determination method (S805). Furthermore, for example, in a case that the HARQ-ACK is transmitted by using the PUCCH format 3, the terminal apparatus 1 may select the first determination method (S804). In a case that the HARQ-ACK is transmitted by using the PUCCH format 2, the terminal apparatus 1 may select the second determination method (S805).

Furthermore, the second condition may also be the HARQ-ACK bit size determined in (S800). For example, in a case that the HARQ-ACK bit size exceeds a prescribed value, the terminal apparatus 1 selects the second determination method. Furthermore, for example, in a case that the HARQ-ACK bit size does not exceed a prescribed value, the terminal apparatus 1 selects the first determination method.

Furthermore, the second condition may be the number of scheduling request configurations having the SR PUCCH resource that has overlapped with the HARQ-ACK PUCCH resource determined in (S800) in the time domain. For example, in a case that the number of scheduling request configurations having the SR PUCCH resource that has overlapped exceeds a prescribed value, the terminal apparatus 1 selects the second determination method. Furthermore, for example, in a case that the number of scheduling request configurations having the SR PUCCH resource that has overlapped does not exceed a prescribed value, the terminal apparatus 1 selects the first determination method. For example, the prescribed value may be 2. Furthermore, for example, the prescribed value may be 7.

(S804) The terminal apparatus 1 determines the scheduling request bit O^{SR} size using the first determination method. The terminal apparatus 1 sets ‘0’ or ‘1’ for each of the scheduling request bits. Here, each of the scheduling request bits may be used to indicate information of the scheduling request for each of the scheduling request configurations having the SR PUCCH resource that has overlapped. Next, the terminal apparatus 1 may add the scheduling request bits to be generated to the rear of the sequence of the HARQ-ACK bits indicating HARQ-ACK feedback. In other words, the scheduling request bits are multiplexed with the HARQ-ACK transmitted in the PUCCH resource for the HARQ-ACK.

(S805) The terminal apparatus 1 determines the scheduling request bit O^{SR} size using the second determination method. The terminal apparatus 1 sets ‘0’ or ‘1’ for each of the scheduling request bits. Here, in a case that the number of scheduling request configurations corresponding to the positive scheduling request is one among the scheduling request configurations, the scheduling request bits O^{SR} may be at least used to indicate the scheduling configuration corresponding to the positive scheduling request. Furthermore, in a case that the number of scheduling request configurations corresponding to the positive scheduling request is more than one among the scheduling request configurations, the scheduling request bits O^{SR} may be at least used to indicate a scheduling request configuration with the highest priority among the scheduling configurations corresponding to the positive scheduling request. Next, the terminal apparatus 1 may add the scheduling request bits to be generated to the rear of the sequence of the HARQ-ACK bits indicating HARQ-ACK feedback. In other words, the scheduling request bits are multiplexed with the HARQ-ACK transmitted in the PUCCH resource for the HARQ-ACK.

Based on the transmission operation described above, the base station apparatus 3 can acquire the information of the scheduling request corresponding to each of the scheduling request configurations based on receiving the UCI bits in the HARQ-ACK PUCCH resource. That is, the base station apparatus 3 can determine whether the scheduling request is a positive scheduling request or a negative scheduling request for each of the scheduling request configurations based on receiving the UCI bits in the HARQ-ACK PUCCH resource.

In other words, in the present embodiment, the terminal apparatus 1 may transmit the HARQ-ACK feedback by using the PUCCH resource for the HARQ-ACK. In a case that the HARQ-ACK PUCCH resource overlaps with the SR PUCCH resource configured from higher layer signaling in the time domain, the scheduling request bit O^{SR} size may be given based on the number of scheduling request configurations having the overlapped SR PUCCH resource. Furthermore, in a case that the PUCCH resource does not overlap with the SR PUCCH resource configured from higher layer signaling in the time domain, the scheduling request bit O^{SR} size may be given as 0. In other words, in a case that the transmission of the scheduling request is configured from the higher layer signaling in a first time unit in which the transmission of the PUCCH format is performed, the scheduling request bit O^{SR} size may be given based on the number of scheduling request configurations for transmission of the scheduling request simultaneously configured in the first time unit. Furthermore, in a case that the transmission of the scheduling request is not configured from the higher layer signaling in the first time unit in which the transmission of the PUCCH format is performed, the scheduling request bit O^{SR} size may be given as 0. Here, the first time unit is a period in which the transmission of the PUCCH format is performed in the time domain, and may be a period in which the HARQ-ACK PUCCH resource used for transmission of the PUCCH format is in the time domain. The HARQ-ACK PUCCH resource may be given at least based on a downlink grant and/or higher layer signaling.

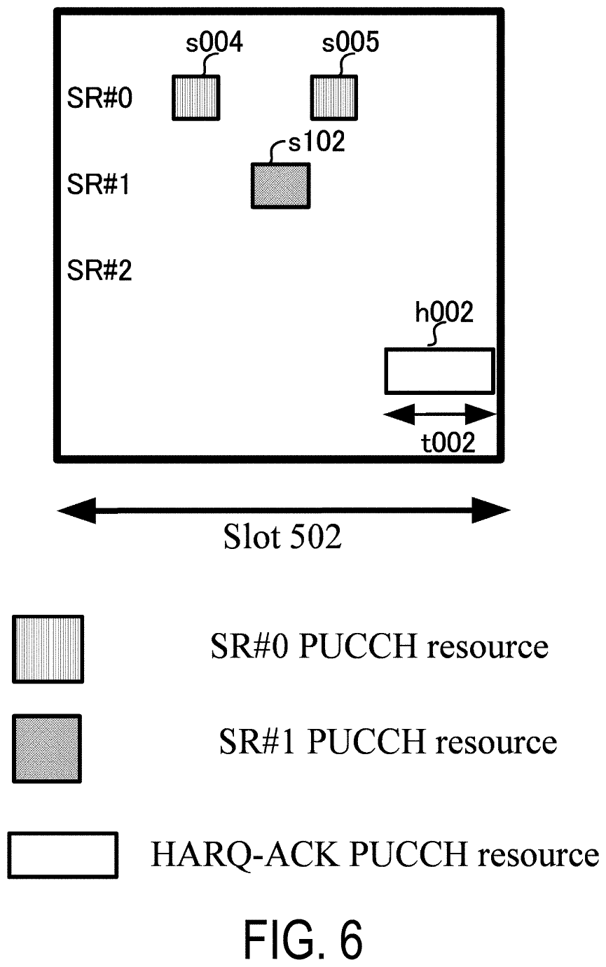

FIG. 6 is a diagram illustrating an example in which a HARQ-ACK PUCCH resource and an SR PUCCH resource do not overlap with each other in the time domain, according to the present embodiment.

In FIG. 6, two scheduling request configurations {SR #0, SR #1} are configured from higher layer signaling in a slot 502 for the terminal apparatus 1. That is, the two scheduling request configurations configured from higher layer signaling correspond to the SR #0 and the SR #1, respectively. In the slot 502, the SR #0 has SR PUCCH resources s004, and s005. In the slot 502, the SR #1 has an SR PUCCH resource s102. A resource h002 is a HARQ-ACK PUCCH resource in the slot 502. In the time domain, t002 is a time unit in which the transmission of the PUCCH format is performed.

For example, in the slot 502, the terminal apparatus 1 transmits HARQ-ACK feedback by the resource h002 using the PUCCH format 2 or 3. In the time unit t002, the SR PUCCH resources {s004, s005} included in the SR #0 and the SR PUCCH resource s102 included in the SR #1 do not overlap with the HARQ-ACK PUCCH resource in the time domain. In this case, the scheduling request bit O^{SR} size may be given as 0. In this case, the terminal apparatus 1 may transmit only the HARQ-ACK using the HARQ-ACK PUCCH resource h002 and the PUCCH format 2 or the PUCCH format 3.

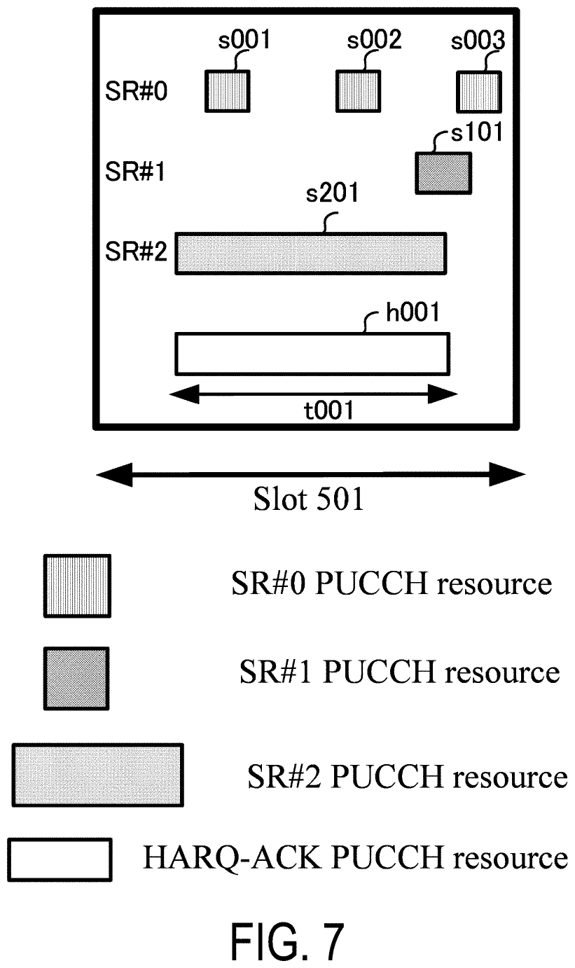

Hereinafter, with reference to FIG. 7, the first determination method and the second determination method used to generate the scheduling request bits O^{SR} will be described in a case that the HARQ-ACK PUCCH resource and the SR PUCCH resource overlap with each other in the time domain. FIG. 7 is a diagram illustrating an example of determining the scheduling request bit size in a case that the HARQ-ACK PUCCH resource and the SR PUCCH resource overlap with each other in the time domain, according to the present embodiment.

Furthermore, in FIG. 7, three scheduling request configurations {SR #0, SR #1, SR #2} are configured from higher layer signaling in a slot 501 for the terminal apparatus 1. That is, the three scheduling request configurations configured from higher layer signaling correspond to the SR #0, the SR #1, and the SR #2, respectively. In the slot 501, the SR #0 has SR PUCCH resources s001, s002, and s003. In the slot 501, the SR #1 has an SR PUCCH resource s101. In the slot 501, the SR #2 has an SR PUCCH resource s201. A resource h001 is a HARQ-ACK PUCCH resource in the slot 501.

For example, in the slot 501, the terminal apparatus 1 transmits HARQ-ACK feedback by the resource h001 using the PUCCH format 2 or 3. In the time domain, t001 is a time unit in which the transmission of the PUCCH format 2 or the PUCCH format 3 is performed. {s001, s002} included in the SR #0, s101 included in the SR #1, and s201 included in the SR #2 overlap with the HARQ-ACK PUCCH resource h001 in the time domain. Here, s003 included in the SR #0 does not overlap with the HARQ-ACK PUCCH resource h001 in the time domain.

That is, in a case that the PUCCH resource for transmission of the HARQ-ACK overlaps with the SR PUCCH resource configured from higher layer signaling in the time domain, the scheduling request bit O^{SR} size may be given by the number of scheduling request configurations having the overlapped SR PUCCH resource. The first determination method is a method in which the scheduling request bit O^{SR} size is set to the number of scheduling request configurations having the overlapped SR PUCCH resource. That is, in a case that the first determination method is used, the scheduling request bit O^{SR} size is the same as the number of scheduling request configurations having the overlapped SR PUCCH resource. Each of the scheduling request bits may be used to indicate information of the scheduling request for each of the scheduling request configurations having the overlapped SR PUCCH resource. In a case that the HARQ-ACK PUCCH resource and the SR PUCCH resource overlap with each other in the time domain, the number of scheduling request configurations having the overlapped SR PUCCH resource is assumed to be K. Using the first determination method, notification of K-bit bitmap information is provided by making to correspond to the K scheduling request configurations. Each information bit of the bitmap corresponds to one scheduling request configuration. For example, in the bitmap information, “1” may be set for the scheduling request configuration corresponding to a positive scheduling request, and “0” may be set for the scheduling request configuration corresponding to a negative scheduling request.

In FIG. 7, the number of scheduling request configurations having the SR PUCCH resource that has overlapped with the HARQ-ACK PUCCH resource h001 is three. In other words, the scheduling request bit O^{SR} size determined by the first determination method is three bits (O^{SR} (0), O^{SR} (1), O^{SR} (2)) of information bits. In this case, each of the information bits of the scheduling request bits O^{SR} corresponds to each of the scheduling request configurations. For example, O^{SR} (0) may correspond to the SR #0. O^{SR} (1) may correspond to the SR #1. O^{SR} (2) may correspond to the SR #2. For the SR #0, in a case that the scheduling request is a positive scheduling request (positive SR), O^{SR} (0) may be set to 1. Furthermore, for the SR #0, in a case that the scheduling request is a negative scheduling request (negative SR), O^{SR} (0) may be set to 0. In the same manner, for the SR #1, in a case that the scheduling request is a positive scheduling request (positive SR), O^{SR} (1) may be set to 1, and in a case that the scheduling request is a negative scheduling request (negative SR), O^{SR} (1) may be set to 0. For the SR #2, in a case that the scheduling request is a positive scheduling request (positive SR), O^{SR} (2) may be set to 1, and in a case that the scheduling request is a negative scheduling request (negative SR), O^{SR} (2) may be set to 0. The terminal apparatus 1 may transmit the HARQ-ACK bit and the scheduling request bit using the PUCCH resource h001 and the PUCCH format 2 or the PUCCH format 3. With this configuration, the base station apparatus 3 can identify the information of the scheduling request for each of the scheduling request configurations based on the transmitted bitmap information.

By the first determination method, the scheduling request is indicated for each of the K scheduling request configurations. By the second determination method, in a case that the number of scheduling request configurations having the overlapped SR PUCCH resource is greater than a prescribed number, the size of O^{SR} can be made to be an appropriate size. The second determination method used to generate the scheduling request bits O^{SR} will be described below.

The second determination method is a method in which the scheduling request bit O^{SR} size is set to the number smaller than the number of scheduling request configurations having the overlapped SR PUCCH resource. For example, the terminal apparatus 1 may transmit HARQ-ACK feedback using the PUCCH resource for the HARQ-ACK using the PUCCH format 2 or the PUCCH format 3. In a case that the HARQ-ACK PUCCH resource and the SR PUCCH resource overlap with each other in the time domain, the number of scheduling request configurations having the overlapped SR PUCCH resource is assumed to be K. The scheduling request bit O^{SR} size determined by using the second determination method is assumed to be L bits. The value of L may be given by L=Ceiling(log₂ (K+1)). Here, Ceiling(*) is a function that rounds up the numerical value * and outputs an integer that is closest to and greater than the numerical value *. For example, in a case that the value of K is 3, L may be 2. Furthermore, for example, in a case that the value of K is 4, L may be 3. Furthermore, for example, in a case that the value of K is 7, L may be 3.

For the scheduling request bit O^{SR} size L, the number of combinations of code points is (2\hat{ } L). (2\hat{ }L) indicates the L-th power of 2. Information of the scheduling request for the (2\hat{ }L) combination of the code points and the scheduling request configurations K will be described below.

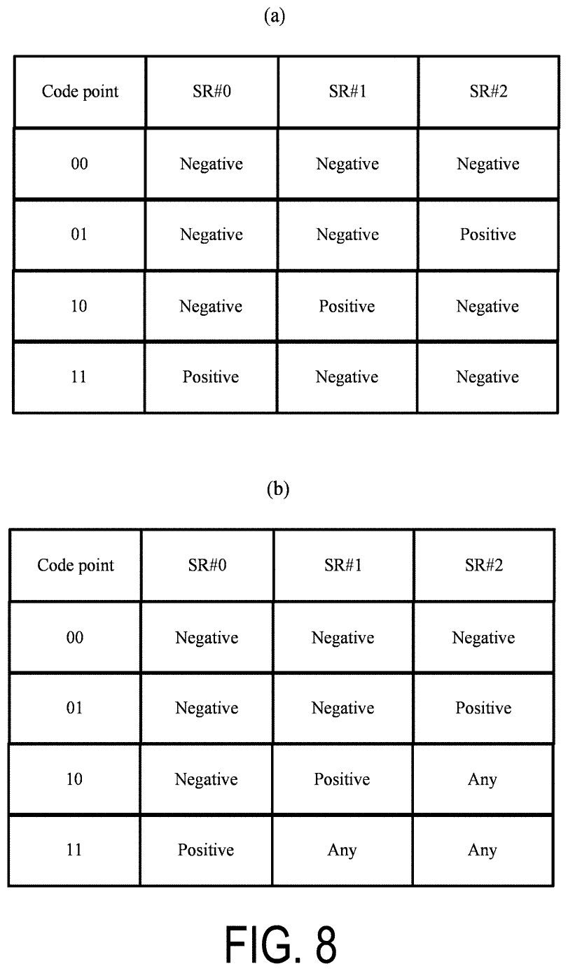

FIG. 8 is a diagram illustrating an example of a mapping table between information of the scheduling request and a code point according to the present embodiment. Here, the information of the scheduling request is information indicating, with respect to each scheduling request configuration, whether the scheduling request is a positive scheduling request or a negative scheduling request. In FIG. 8, the number K of scheduling request configurations having the SR PUCCH resource that has overlapped with the HARQ-ACK PUCCH resource in the time domain may be 3. The scheduling request configurations correspond to the SR #0, the SR #1, and the SR #2, respectively. For example, the SR #0 with the minimum index may have the highest priority. That is, in a manner that a hamming distance between a first code point to which the scheduling request configuration with the highest priority is mapped and a second code point to which a Negative SR is mapped is maximized, the scheduling request configuration with the highest priority and the Negative SR may be mapped. For example, by the hamming distance between the first code point and the second code point being maximized, it is expected that the probability of detection error for the first code point and the second code point will be reduced. The SR #2 with the maximum index may have the lowest priority. In FIG. 8, the scheduling request bit O^{SR} size L is two bits, and can correspond to four code points (four states). In FIG. 8, the scheduling request bits O^{SR} include {O^{SR} (0), O^{SR} (1)}. In FIG. 8, ‘Positive’ denotes a positive scheduling request. ‘Negative’ denotes a negative scheduling request. ‘Any’ denotes that any of a positive scheduling request and a negative scheduling request is used.

In FIG. 8(a), among the K scheduling request configurations, the number of scheduling request configurations corresponding to a positive scheduling request is zero or one. For example, in a case that the scheduling requests are triggered for the multiple scheduling request configurations, the MAC layer may select a scheduling request configuration with the highest priority among the multiple scheduling request configurations, and provide, to the physical layer, a notification/indication to signal the scheduling request. The physical layer may then transmit the scheduling request for the notified scheduling request configuration based on the indication from the MAC layer. In other words, for the scheduling request configuration notified from the MAC layer, the scheduling request is a positive scheduling request. For the other scheduling request configurations, the scheduling request is a negative scheduling request.

In FIG. 8(a), one among the four code points is used to indicate that the scheduling request is a negative scheduling request for each of the K scheduling request configurations. Other code points are used to indicate the scheduling request configuration corresponding to a positive scheduling request. In other words, the information indicating the scheduling request configuration corresponding to the positive scheduling request may be taken as the code point. Here, taking the information indicating the scheduling request configuration corresponding to the positive scheduling request as the code point may be that the code point is selected based on the information indicating the scheduling request configuration corresponding to the positive scheduling request. The base station apparatus 3 can determine the information of the scheduling request for the scheduling request configuration based on the code point of which the terminal apparatus 1 has notified thereto. For example, in FIG. 8(a), O^{SR} (0) O^{SR} (1) set as “00” may be used to indicate that the scheduling request is a negative scheduling request for each of the SR #0, the SR #1, and the SR #2. O^{SR} (0) O^{SR} (1) set as “01” may be used to indicate that the scheduling request is a negative scheduling request for each of the SR #0 and the SR #1, and to indicate that the scheduling request is a positive scheduling request for the SR #2. O^{SR} (0) O^{SR} (1) set as “10” may be used to indicate that the scheduling request is a negative scheduling request for each of the SR #0 and the SR #2, and to indicate that the scheduling request is a positive scheduling request for the SR #1. O^{SR} (0) O^{SR} (1) set as “11” may be used to indicate that the scheduling request is a negative scheduling request for each of the SR #1 and the SR #2, and to indicate that the scheduling request is a positive scheduling request for the SR #0.

In FIG. 8(b), among the K scheduling request configurations, the number of scheduling request configurations corresponding to a positive scheduling request may be zero, one, or a number more than one. For example, in a case that the scheduling requests are triggered for the multiple scheduling request configurations, the MAC layer may provide, to the physical layer, a notification/indication to signal the scheduling request for each of the multiple scheduling request configurations for which the trigger is performed. The physical layer may then transmit the scheduling request for the notified scheduling request configuration based on the indication from the MAC layer. In other words, in the time domain of the HARQ-ACK PUCCH resource, the number of scheduling request configurations corresponding to the positive scheduling request may be a plural number.

In FIG. 8(b), one among the four code points is used to indicate that the scheduling request is a negative scheduling request for each of the SR #0, the SR #1, and the SR #2. Other code points are used to indicate a scheduling configuration with the highest priority among the scheduling request configurations corresponding to a positive scheduling request. In FIG. 8(b), O^{SR} (0) O^{SR} (1) set as “00” may be used to indicate that the scheduling request is a negative scheduling request for each of the SR #0, the SR #1, and the SR #2. O^{SR} (0) O^{SR} (1) set as “01” may be used to indicate that the scheduling request is a positive scheduling request for the SR #2, and to indicate that the scheduling request is a negative scheduling request for each of the SR #0 and the SR #1 with higher priority than that of the SR #2. O^{SR} (0) O^{SR} (1) set as “10” may indicate that the scheduling request is a positive scheduling request for the SR #1, may indicate that the scheduling request is a negative scheduling request for the SR #0 with higher priority than that of the SR #1, and may not indicate the information of the scheduling request for the SR #2 with lower priority than that of the SR #1. O^{SR} (0) O^{SR} (1) set as “11” may indicate that the scheduling request is a positive scheduling request for the SR #0, and may not indicate the information of the scheduling request for the SR #1 and the SR #2 with lower priority than that of the SR #0. With this configuration, the base station apparatus 3 can know a scheduling request configuration with the highest priority among the scheduling request configurations for the positive scheduling request.

Furthermore, in a case that the number of bits of the HARQ-ACK feedback is equal to or less than a prescribed value, the size L of O^{SR} may be one, regardless of the number of scheduling request configurations having the SR PUCCH resource that has overlapped with the HARQ-ACK PUCCH resource in the time domain. The prescribed value may be, for example, 11 bits. In a case that the O^{SR} size L=1 is satisfied, a scheduling request associated with a logical channel with the highest priority may be transmitted. In a case that the O^{SR} size L=1 is satisfied, a scheduling request associated with a logical channel with the lowest priority may be transmitted.

Furthermore, as another aspect of the present embodiment, in a case that the terminal apparatus 1 transmits HARQ-ACK feedback using the PUCCH format 4 and the HARQ-ACK PUCCH resource, in a case that the HARQ-ACK PUCCH resource and the SR PUCCH resource overlap with each other in the time domain, the scheduling request bit O^{SR} size may be given as one not based on the number of scheduling request configurations having the overlapped SR PUCCH resource. In other words, even in a case that the number of scheduling request configurations having the overlapped SR PUCCH resource is greater than one, the terminal apparatus 1 may set the scheduling request bit O^{SR} size to one.

Furthermore, in a case that the terminal apparatus 1 transmits HARQ-ACK feedback using the HARQ-ACK PUCCH resource and the PUCCH format 2 or 3, in a case that the HARQ-ACK PUCCH resource and the SR PUCCH resource overlap with each other in the time domain, the scheduling request bit O^{SR} size may be given based on the number of scheduling request configurations having the overlapped SR PUCCH resource. In other words, even in a case that the number of scheduling request configurations having the overlapped SR PUCCH resource is greater than one, the terminal apparatus 1 may set the scheduling request bit O^{SR} size to one or more bits.

Hereinafter, as another aspect of the present embodiment, in a case that the terminal apparatus 1 transmits HARQ-ACK feedback using the HARQ-ACK PUCCH resource, in a case that the HARQ-ACK PUCCH resource and the SR PUCCH resource overlap with each other in the time domain, another example in which the scheduling request bit size is determined will be described.

As described above, the first determination method is a method in which the scheduling request bit O^{SR} size is set to the number of scheduling request configurations having the SR PUCCH resource that has overlapped with the HARQ-ACK PUCCH resource in the time domain. Furthermore, the first determination method may be a method in which the scheduling request bit O^{SR} size is set to the number of scheduling request configurations configured from higher layer signaling, regardless of the number of scheduling request configurations having the SR PUCCH resource that has overlapped with the HARQ-ACK PUCCH resource in the time domain.

The number of scheduling request configurations may be given by higher layer signaling for each PUCCH format.

The first determination method may be a method in which the scheduling request bit O^{SR} size is set at least based on higher layer signaling, regardless of the number of scheduling request configurations having the SR PUCCH resource that has overlapped with the HARQ-ACK PUCCH resource in the time domain.

For example, N scheduling request configurations are configured from higher layer signaling for the terminal apparatus 1. Additionally, the scheduling request bit O^{SR} size multiplexed with a HARQ-ACK sequence may be set to N. Each information bit of O^{SR} corresponds to one of the scheduling request configurations configured from higher layer signaling. The information bit of the O^{SR} and the scheduling request configuration are mapped on a one-to-one basis. Each of the scheduling request bits O^{SR} may be used to indicate information of the scheduling request for each of the scheduling request configurations configured from higher layer signaling. In other words, the terminal apparatus 1 may notify the base station apparatus 3 of the information of the scheduling request for each of N scheduling request configurations using an N-bit bitmap form. For example, among the scheduling request configurations having the SR PUCCH resource that has overlapped with the HARQ-ACK PUCCH resource in the time domain, the terminal apparatus 1 may set, to “1”, an information bit to which the scheduling request configuration corresponding to a positive scheduling request corresponds, and set, to “0”, an information bit to which the scheduling request configuration corresponding to a negative scheduling request corresponds. Furthermore, the terminal apparatus 1 may set, to “0”, the information bit to which the scheduling request configuration not having the SR PUCCH resource that has overlapped with the HARQ-ACK PUCCH resource in the time domain corresponds.

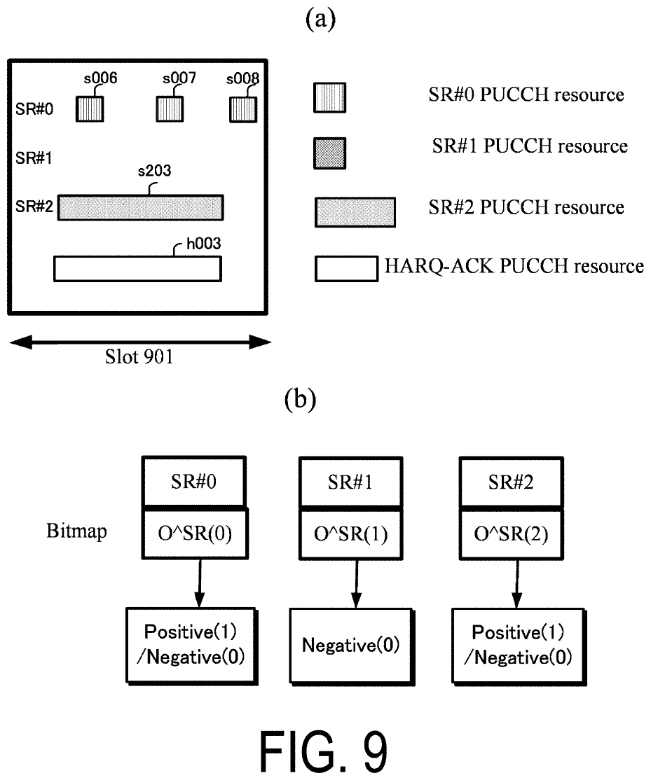

FIG. 9 is a diagram illustrating another example of determining the scheduling request bit size in a case that a HARQ-ACK PUCCH resource and an SR PUCCH resource overlap with each other in the time domain, according to the present embodiment.

In FIG. 9, three scheduling request configurations {SR #0, SR #1, SR #2} are configured from higher layer signaling for the terminal apparatus 1. That is, the number N of scheduling request configurations configured from higher layer signaling is three. In a slot 901, the SR #0 has SR PUCCH resources s006, s007, and s008. In the slot 901, the SR #1 does not have an SR PUCCH resource. In the slot 901, the SR #2 has an SR PUCCH resource s203. A resource h003 is a HARQ-ACK PUCCH resource in the slot 901. {s006, s007} included in the SR #0 and s203 included in the SR #2 overlap with the HARQ-ACK PUCCH resource h003 in the time domain. In other words, the number K of scheduling request configurations having the SR PUCCH resource that has overlapped with the HARQ-ACK PUCCH resource is two.

In FIG. 9(a), the terminal apparatus 1 sets, based on whether the scheduling request is a positive scheduling request or a negative scheduling request for the SR #0, the information bit O^{SR} (0) to which the SR #0 corresponds to either “1” or “0”. Furthermore, the terminal apparatus 1 may set, to “0”, the information bit O^{SR} (1) to which the SR #1 not having the SR PUCCH resource that has overlapped with the HARQ-ACK PUCCH resource in the time domain corresponds. The terminal apparatus 1 sets, based on whether the scheduling request is a positive scheduling request or a negative scheduling request for the SR #2, the information bit O^{SR} (2) to which the SR #2 corresponds to either “1” or “0”. Next, the terminal apparatus 1 may notify the base station apparatus 3 of the information of the scheduling request for each of three scheduling request configurations using a bitmap form as illustrated in FIG. 9(b). For example, using the HARQ-ACK PUCCH resource, the terminal apparatus 1 multiplexes bitmap information (1, 0, 0) with the HARQ-ACK, and transmits the result to the base station apparatus 3. Based on the bitmap information (1, 0, 0), the base station apparatus 3 can determine that the scheduling request is a positive scheduling request for the SR #0, and that the scheduling request is a negative scheduling request for the SR #2.

Furthermore, in the present aspect, the second determination method is a method in which the scheduling request bit O^{SR} size is set to the number smaller than the number N of scheduling request configurations configured from higher layer signaling. That is, the scheduling request bit O^{SR} size is related to the number of scheduling request configurations configured from higher layer signaling, regardless of the number K of scheduling request configurations having the SR PUCCH resource that has overlapped with the HARQ-ACK PUCCH resource in the time domain. For example, N scheduling request configurations are configured from higher layer signaling for the terminal apparatus 1. Additionally, a scheduling request bit O^{SR} size L multiplexed with a HARQ-ACK sequence may be given by L=Ceiling (log₂(N+1)). For example, in a case that the value of N is 3, L may be 2. Furthermore, for example, in a case that the value of N is 4, L may be 3. Furthermore, for example, in a case that the value of K is 7, L may be 3.

Next, the second determination method according to the present aspect will be described. Three scheduling request configurations {SR #0, SR #1, SR #2 } are configured from higher layer signaling for the terminal apparatus 1. Here, a value of N is 3. The scheduling request bit O^{SR} size L multiplexed with a HARQ-ACK sequence may be given by 2 based on L=Ceiling (log₂(3+1)). Four combinations (patterns, states) are formed from information bits of two bits. Next, a description will be given with reference to FIG. 8(a). The terminal apparatus 1 may take information of the scheduling request as four code points, for three scheduling request configurations. Here, taking the information of the scheduling request as the code point may be that the code point is selected based on the information of the scheduling request. For example, the terminal apparatus 1 may take information indicating that the scheduling request is a negative scheduling request as a code point (e.g., “00”), for three scheduling request configurations. Furthermore, for example, the terminal apparatus 1 may take information indicating that the scheduling request is a positive scheduling request as a code point (e.g., “01”), for the SR #2. Furthermore, for example, the terminal apparatus 1 may take information indicating that the scheduling request is a positive scheduling request as a code point (e.g., “10”), for the SR #1. Furthermore, for example, the terminal apparatus 1 may take information indicating that the scheduling request is a positive scheduling request as a code point (e.g., “11”), for the SR #0.

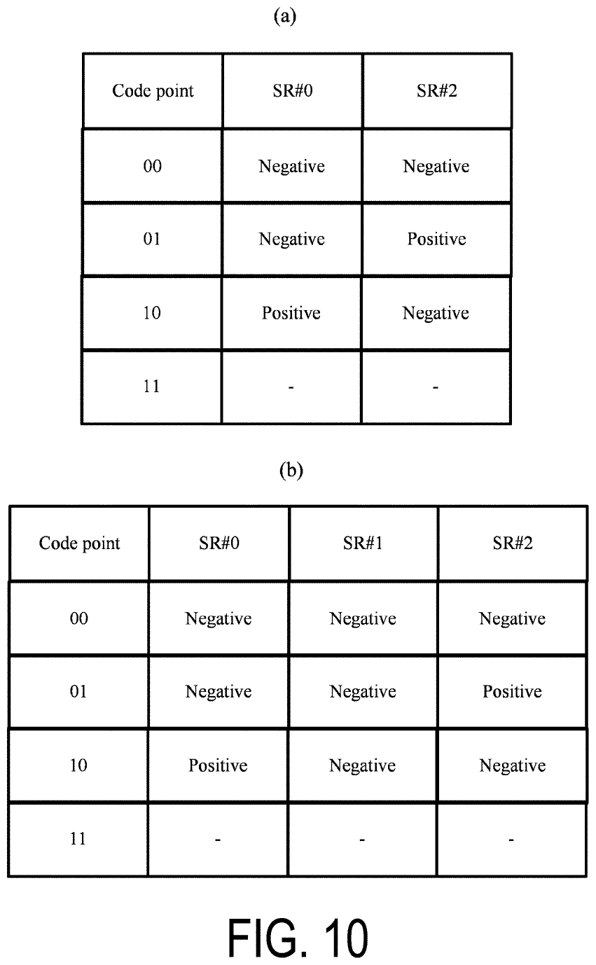

In a case that the value of K and the value of N are the same, the terminal apparatus 1 may indicate information of the scheduling request for the scheduling request configuration configured from higher layer signaling, using FIG. 8. Next, in a case that a value of K is smaller than a value of N, the information of the scheduling request indicated by the code point will be described. For example, referring to FIG. 10(a), the value of K is 2, that is, the number of scheduling request configurations (SR #0, SR #2) having the SR PUCCH resource that has overlapped with the HARQ-ACK PUCCH resource used for transmission of HARQ-ACK in the time domain is two. The SR PUCCH resource included in the SR #1 does not overlap with the HARQ-ACK PUCCH resource in the time domain. In this case, interpretation of the information of the scheduling request indicated by the code point may be changed. For example, as illustrated in FIG. 10(a), the terminal apparatus 1 may take information indicating that the scheduling request is a negative scheduling request as a code point (e.g., “00”), for the SR #0 and the SR #2. Furthermore, for example, the terminal apparatus 1 may take information indicating that the scheduling request is a positive scheduling request as a code point (e.g., “01”), for the SR #2. Furthermore, for example, the terminal apparatus 1 may take information indicating that the scheduling request is a positive scheduling request as a code point (e.g., “10”), for the SR #0. Here, the terminal apparatus 1 may use three code points, in order to indicate the information of the scheduling request for two scheduling request configurations (SR #0, SR #2). Then, the remaining one code point “11” may not be used to indicate the information of the scheduling request. In other words, the terminal apparatus 1 may not notify the base station apparatus 3 of the code point set to “11”. Furthermore, the terminal apparatus 1 may reinterpret the code point set to “11”. For example, the terminal apparatus 1 may take information indicating that the scheduling request is a positive scheduling request as a code point (“11”), for each of the SR #0 and the SR #2. Furthermore, as illustrated in FIG. 10(b), the three code points can be used to indicate the information of the scheduling request for the SR #0 and the SR #2. These three code points may indicate that the scheduling request is a negative scheduling request, for the SR #1. Then, the remaining one code point “11” may not be used to indicate the information of the scheduling request. With this configuration, the base station apparatus 3 can determine the information of the scheduling request for the scheduling request configuration based on the code point of which the terminal apparatus 1 has notified thereto.

Hereinafter, in the present embodiment, an example will be described in which the terminal apparatus 1 transmits HARQ-ACK and a scheduling request by using the PUCCH format 0 in a case that the HARQ-ACK resource overlaps with one SR PUCCH resource in the time domain.

In a case that the terminal apparatus 1 transmits the HARQ-ACK and a negative scheduling request by using the PUCCH format 0, the terminal apparatus 1 may transmit the PUCCH format 0 by a PRB for HARQ-ACK transmission. In other words, in a case that the terminal apparatus 1 transmits the HARQ-ACK and the negative scheduling request by using the PUCCH format 0, the terminal apparatus 1 may transmit the HARQ-ACK by using the PUCCH format 0 in the HARQ-ACK PUCCH resource. In other words, in a case that the HARQ-ACK resource overlaps with one SR PUCCH resource in the time domain, and the terminal apparatus 1 transmits the HARQ-ACK and the scheduling request, and the scheduling request is the negative scheduling request, and the PUCCH format of the HARQ-ACK PUCCH resource for the HARQ-ACK transmission is the PUCCH format 0, the terminal apparatus 1 may transmit the HARQ-ACK by using the PUCCH format 0 in the HARQ-ACK PUCCH resource.

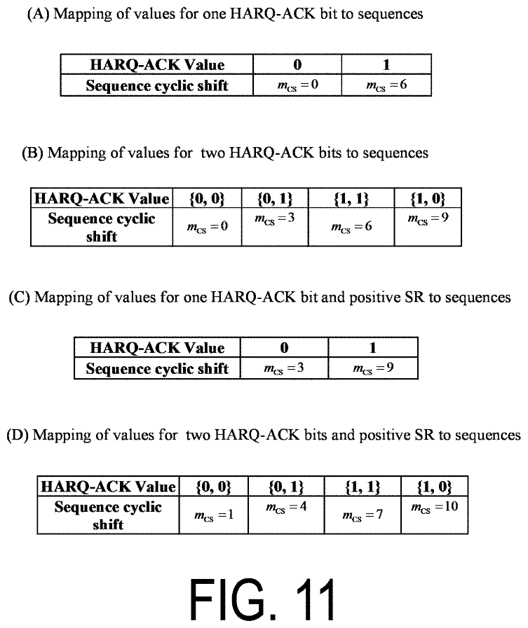

A PRB index of the HARQ-ACK PUCCH resource may be given at least based on a PUCCH resource indicator field included in a DCI format 1_0 or a DCI format 1_1 detected from the PDCCH. A value of a cyclic shift a used in a sequence for the PUCCH format 0 may be calculated by initial values m₀ and m_{cs}. The initial value m₀ of the cyclic shift is indicated from a higher layer parameter. As illustrated in FIGS. 11(A) and (B), each m_{cs} may be determined from a value of one HARQ-ACK bit or values of two HARQ-ACK bits. FIG. 11 is a diagram illustrating an example of mapping values of a HARQ-ACK bit or values of a HARQ-ACK bit and a positive scheduling request to sequences, according to the present embodiment. In FIGS. 11(A) and (B), in a case that the HARQ-ACK is NACK, the value of HARQ-ACK may be mapped to 0. In a case that the HARQ-ACK is ACK, the value of HARQ-ACK may be mapped as 1.

The PUCCH resource indicator field may be used to indicate at least a PUCCH resource in a prescribed PUCCH resource set. The PUCCH resource set may include one or multiple PUCCH resources. That is, each code point given by a bit sequence of the PUCCH resource indicator field may correspond to one PUCCH resource (or an index of one PUCCH resource). The prescribed PUCCH resource set may be given from one or multiple PUCCH resource sets at least based on the number of UCI bits.

For example, in a case that the number of UCI bits to be transmitted is equal to or less than two, a first PUCCH resource set may be selected as the prescribed PUCCH resource set. Furthermore, in a case that the number of UCI bits to be transmitted is greater than two, and the number of UCI bits to be transmitted is equal to or less than N_{2PUCCH_RESET}, a second PUCCH resource set may be selected as the prescribed PUCCH resource set. Furthermore, in a case that the number of UCI bits to be transmitted is greater than N_{2PUCCH_RESET}, and the number of UCI bits to be transmitted is equal to or less than N_{3PUCCH_RESET}, a third PUCCH resource set may be selected as the prescribed PUCCH resource set. Furthermore, in a case that the number of UCI bits to be transmitted is greater than N_{3PUCCH_RESET}, and the number of UCI bits to be transmitted is equal to or less than N_{4PUCCH_RESET}, a fourth PUCCH resource set may be selected as the prescribed PUCCH resource set. N_{2PUCCH_RESET} may be given at least based on a higher layer parameter. N_{3PUCCH_RESET} may be given at least based on a higher layer parameter. N_{4PUCCH_RESET} may be given at least based on a higher layer parameter. N_{4PUCCH_RESET} may be the maximum value of the number of UCI bits to be transmitted.

The number of UCI bits may be given at least based on some or all of the number of SR bits (scheduling request bits), the number of HARQ-ACK bits, and/or the number of CSI bits.

The configuration indicating the PRB index of the HARQ-ACK PUCCH resource may be included in a PUCCH resource configuration. The PUCCH resource configuration may be a configuration for the PUCCH resource. The PUCCH resource configuration may be given at least based on a higher layer parameter. The PUCCH resource configuration may at least indicate some or all of 1) an OFDM symbol at the top of the PUCCH (or the top OFDM symbol to which the PUCCH is mapped), 2) the number of OFDM symbols of the PUCCH (or the number of OFDM symbols to which the PUCCH is mapped), 3) whether or not frequency hopping is applied, 4) a value of the cyclic shift used in a sequence for the PUCCH format, and/or 5) the number of PRBs of the PUCCH (or the number of PRBs to which the PUCCH is mapped).

A PUCCH resource configuration for the PUCCH format 0 may not indicate a value of a cyclic shift used in a sequence for the PUCCH format 0.

Furthermore, in a case that the terminal apparatus 1 transmits the HARQ-ACK and a positive scheduling request by using the PUCCH format 0, the terminal apparatus 1 may transmit the PUCCH format 0 by a PRB for HARQ-ACK transmission. In other words, in a case that the terminal apparatus 1 transmits the HARQ-ACK and the positive scheduling request by using the PUCCH format 0, the terminal apparatus 1 may transmit the HARQ-ACK by using the PUCCH format 0 in the HARQ-ACK PUCCH resource. In other words, in a case that the HARQ-ACK resource overlaps with one SR PUCCH resource in the time domain, and the terminal apparatus 1 transmits the HARQ-ACK and a scheduling request, and the scheduling request is the positive scheduling request, and the PUCCH format of the HARQ-ACK PUCCH resource for the HARQ-ACK transmission is the PUCCH format 0, the terminal apparatus 1 may transmit the HARQ-ACK by using the PUCCH format 0 in the HARQ-ACK PUCCH resource.

A value of the cyclic shift a used in a sequence for the PUCCH format 0 may be calculated by the initial values m₀ and m_{cs}. The initial value m₀ of the cyclic shift is indicated from a higher layer parameter. Here, as illustrated in FIGS. 11(C) and (D), each mₑ, may be determined from values of one HARQ-ACK bit and the positive scheduling request or values of two HARQ-ACK bits and the positive scheduling request. In FIGS. 11(C) and (D), in a case that the HARQ-ACK is NACK, the value of HARQ-ACK may be mapped as 0. In a case that the HARQ-ACK is ACK, the value of HARQ-ACK may be mapped as 1.

In this way, the base station apparatus 3 can identify information of the HARQ-ACK and/or information of the scheduling request, at least based on information of the cyclic shift a used for the PUCCH format 0 transmitted in the HARQ-ACK PUCCH resource. For example, in a case of two HARQ-ACK bits, and a value of m_{cs} is calculated as 1, the base station apparatus 3 may identify the two HARQ-ACK bits as NACK and the scheduling request as the positive scheduling request.

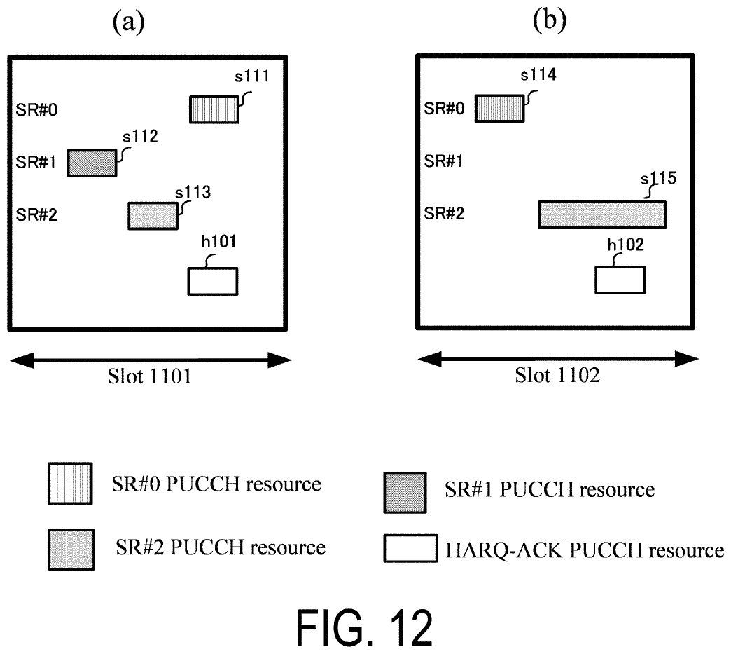

FIG. 12 is a diagram illustrating an example of transmitting HARQ-ACK and a scheduling request using the PUCCH format 0, according to the present embodiment.

In FIG. 12(a), in a slot 1101, the SR #0 has an SR PUCCH resource s111. In the slot 1101, the SR #1 has an SR PUCCH resource s112. In the slot 1101, the SR #2 has an SR PUCCH resource s113. A resource h101 is a HARQ-ACK PUCCH resource in the slot 1101. Here, the SR PUCCH resource sill may be a resource that uses the PUCCH format 0 by a configuration of a higher layer parameter. The HARQ-ACK resource h101 may be a resource that uses the PUCCH format 0 at least based on the PUCCH resource indicator field included in the DCI format 1_0 or the DCI format 1_1 detected from the PDCCH. In FIG. 12(a), the SR PUCCH resource sill overlaps with the HARQ-ACK PUCCH resource h101 in the time domain. That is, the HARQ-ACK PUCCH resource overlaps with one SR PUCCH resource in the time domain. In FIG. 12(a), in a case that the terminal apparatus 1 transmits the HARQ-ACK and a negative scheduling request, the terminal apparatus 1 may transmit the HARQ-ACK by using the PUCCH format 0 in the HARQ-ACK PUCCH resource h101. In a case that the terminal apparatus 1 transmits the HARQ-ACK and a positive scheduling request, the terminal apparatus 1 may transmit the HARQ-ACK and the positive scheduling by using the PUCCH format 0 in the HARQ-ACK PUCCH resource h101.

In FIG. 12(b) and FIG. 11(b), in a slot 1102, the SR #0 has an SR PUCCH resource s114. In the slot 1102, the SR #2 does not have an SR PUCCH resource. In the slot 1102, the SR #2 has an SR PUCCH resource s115. A resource h102 is a HARQ-ACK PUCCH resource in the slot 1102. Here, the SR PUCCH resource s115 may be a resource that uses the PUCCH format 1 by a configuration of a higher layer parameter. The HARQ-ACK resource h102 may be a resource that uses the PUCCH format 0 at least based on the PUCCH resource indicator field included in the DCI format 1_0 or the DCI format 1_1 detected from the PDCCH. In FIG. 12(b), the SR PUCCH resource s115 overlaps with the HARQ-ACK PUCCH resource h102 in the time domain. That is, the HARQ-ACK PUCCH resource overlaps with one SR PUCCH resource in the time domain. In FIG. 12(b), in a case that the terminal apparatus 1 transmits the HARQ-ACK and a negative scheduling request, the terminal apparatus 1 may transmit the HARQ-ACK by using the PUCCH format 0 in the HARQ-ACK PUCCH resource h102. In a case that the terminal apparatus 1 transmits the HARQ-ACK and a positive scheduling request, the terminal apparatus 1 may transmit the HARQ-ACK and the positive scheduling by using the PUCCH format 0 in the HARQ-ACK PUCCH resource h102.

In other words, in the present embodiment, in a case that the HARQ-ACK PUCCH resource overlaps with one SR PUCCH resource in the time domain, and in a case that the terminal apparatus 1 transmits the HARQ-ACK and the scheduling request by using the PUCCH format 0, the terminal apparatus 1 may transmit the HARQ-ACK and the scheduling request by using the HARQ-ACK PUCCH resource, regardless of whether the scheduling request is a positive scheduling request or a negative scheduling request.

Hereinafter, an example will be described in which, in a case that the terminal apparatus 1 transmits HARQ-ACK by using the PUCCH format 0, the terminal apparatus 1 transmits the HARQ-ACK and a scheduling request by using the PUCCH format 0 in a case that a HARQ-ACK resource overlaps with more than one SR PUCCH resource in the time domain.

In other words, in a case that the terminal apparatus 1 transmits the HARQ-ACK by using the PUCCH format 0, in a case that the HARQ-ACK PUCCH resource overlaps with more than one SR PUCCH resource in the time domain, and in a case that the scheduling request for each of the overlapped SR PUCCH resources is a negative scheduling request, the terminal apparatus 1 may transmit the HARQ-ACK and the negative scheduling request by using the PUCCH format 0, on the HARQ-ACK PUCCH resource. The fact that the scheduling request for each of the SR PUCCH resources is the negative scheduling request may be that the physical layer has not received, from the MAC layer, a notification/indication to signal a positive scheduling request by an effective PUCCH resource. The HARQ-ACK PUCCH resource for HARQ-ACK transmission may be given at least based on the PUCCH resource indicator field included in the DCI format 1_0 or the DCI format 1_1 detected from the PDCCH. In other words, in a case that the HARQ-ACK resource overlaps with more than one SR PUCCH resource in the time domain, and the terminal apparatus 1 transmits the HARQ-ACK and the scheduling request, and the scheduling request is the negative scheduling request, and the PUCCH format of the HARQ-ACK PUCCH resource for the HARQ-ACK transmission is the PUCCH format 0, the terminal apparatus 1 may transmit the HARQ-ACK by using the PUCCH format 0 in the HARQ-ACK PUCCH resource.

Furthermore, in a case that the terminal apparatus 1 transmits the HARQ-ACK by using the PUCCH format 0, in a case that the HARQ-ACK PUCCH resource overlaps with more than one SR PUCCH resource in the time domain, and in a case that a scheduling request for at least one SR PUCCH resource among the overlapped SR PUCCH resources is a positive scheduling request, the terminal apparatus 1 may transmit the HARQ-ACK and the positive scheduling request by using the PUCCH format 0, on the SR PUCCH resource to which the positive scheduling request corresponds. In other words, in a case that the HARQ-ACK resource overlaps with more than one SR PUCCH resource in the time domain, and the terminal apparatus 1 transmits the HARQ-ACK and the scheduling request, and the scheduling request is the positive scheduling request, and the PUCCH format of the HARQ-ACK PUCCH resource for the HARQ-ACK transmission is the PUCCH format 0, the terminal apparatus 1 may transmit the HARQ-ACK by using the PUCCH format 0 or the PUCCH format 1 in the SR PUCCH resource, to which the positive scheduling request corresponds, among the more than one SR PUCCH resource. The SR PUCCH resource to which the positive scheduling request corresponds may be an SR PUCCH resource indicated by the MAC layer. The SR PUCCH resource may be given based on a configuration of a higher layer parameter. For a triggered scheduling request configuration, the MAC layer may provide, to the physical layer, a notification/indication to signal the positive scheduling request by an effective PUCCH resource for the positive scheduling request transmission. The MAC layer may select one from among more than one effective PUCCH resource for the positive scheduling request transmission and provide, to the physical layer, a notification/indication to signal the positive scheduling request by the selected effective PUCCH resource. The physical layer may transmit the HARQ-ACK and the positive scheduling request by the SR PUCCH resource notified from the MAC layer among the more than one SR PUCCH resource, based on the indication from the MAC layer.

In a case that the HARQ-ACK resource overlaps with one or multiple SR PUCCH resources in the time domain, and the terminal apparatus 1 transmits the HARQ-ACK and the scheduling request, and the scheduling request is the positive scheduling request, and the PUCCH format of the HARQ-ACK PUCCH resource for the HARQ-ACK transmission is the PUCCH format 0, based on the number of SR PUCCH resources with which the HARQ-ACK PUCCH resource overlaps in the time domain, the terminal apparatus 1 selects the HARQ-ACK PUCCH resource or the SR PUCCH resource indicated by the MAC layer, and transmits the HARQ-ACK and the positive scheduling request by the selected resource.

In a case that the HARQ-ACK resource overlaps with one or multiple SR PUCCH resources in the time domain, and the terminal apparatus 1 transmits the HARQ-ACK and the scheduling request, and the scheduling request is the positive scheduling request, and the PUCCH format of the HARQ-ACK PUCCH resource for the HARQ-ACK transmission is the PUCCH format 1, regardless of the number of SR PUCCH resources with which the HARQ-ACK PUCCH resource overlaps in the time domain, the terminal apparatus 1 selects the SR PUCCH resource indicated by the MAC layer of the HARQ-ACK PUCCH resource and the SR PUCCH resource indicated by the MAC layer, and transmits the HARQ-ACK by the selected SR PUCCH resource.

The above-described method in which the terminal apparatus 1 transmits the HARQ-ACK and the scheduling request by using the PUCCH format 0 in a case that the HARQ-ACK resource overlaps with one or multiple SR PUCCH resources in the time domain may be applied to a method in which the terminal apparatus 1 transmits the HARQ-ACK and the scheduling request by using the PUCCH format 0 in a case that the HARQ-ACK resource overlaps with one or multiple SR PUCCH resources in the time domain.

That is, in a case that the HARQ-ACK resource overlaps with one SR PUCCH resource in the time domain, and the terminal apparatus 1 transmits the HARQ-ACK and the scheduling request, and the scheduling request is the negative scheduling request, and the PUCCH format of the HARQ-ACK PUCCH resource for the HARQ-ACK transmission is the PUCCH format 1, the terminal apparatus 1 may transmit the HARQ-ACK by using the PUCCH format 1 in the HARQ-ACK PUCCH resource.

That is, in a case that the HARQ-ACK resource overlaps with more than one SR PUCCH resource in the time domain, and the terminal apparatus 1 transmits the HARQ-ACK and the scheduling request, and the scheduling request is the negative scheduling request, and the PUCCH format of the HARQ-ACK PUCCH resource for the HARQ-ACK transmission is the PUCCH format 1, the terminal apparatus 1 may transmit the HARQ-ACK by using the PUCCH format 1 in the HARQ-ACK PUCCH resource.

That is, in a case that the HARQ-ACK resource overlaps with one SR PUCCH resource in the time domain, and the terminal apparatus 1 transmits the HARQ-ACK and the scheduling request, and the scheduling request is the positive scheduling request, and the PUCCH format of the HARQ-ACK PUCCH resource for the HARQ-ACK transmission is the PUCCH format 1, the terminal apparatus 1 may transmit the HARQ-ACK by using the PUCCH format 1 in the HARQ-ACK PUCCH resource.

That is, in a case that the HARQ-ACK resource overlaps with more than one SR PUCCH resource in the time domain, and the terminal apparatus 1 transmits the HARQ-ACK and the scheduling request, and the scheduling request is the positive scheduling request, and the PUCCH format of the HARQ-ACK PUCCH resource for the HARQ-ACK transmission is the PUCCH format 1, the terminal apparatus 1 may transmit the HARQ-ACK by using the PUCCH format 0 or the PUCCH format 1 in the SR PUCCH resource to which the positive scheduling request corresponds, among the more than one SR PUCCH resource. The SR PUCCH resource to which the positive scheduling request corresponds may be an SR PUCCH resource indicated by the MAC layer.

That is, in a case that the HARQ-ACK resource overlaps with one or multiple SR PUCCH resources in the time domain, and the terminal apparatus 1 transmits the HARQ-ACK and the scheduling request, and the scheduling request is the positive scheduling request, and the PUCCH format of the HARQ-ACK PUCCH resource for the HARQ-ACK transmission is the PUCCH format 1, based on the number of SR PUCCH resources with which the HARQ-ACK PUCCH resource overlaps in the time domain, the terminal apparatus 1 selects the HARQ-ACK PUCCH resource or the SR PUCCH resource indicated by the MAC layer, and transmits the HARQ-ACK and the positive scheduling request by the selected resource.

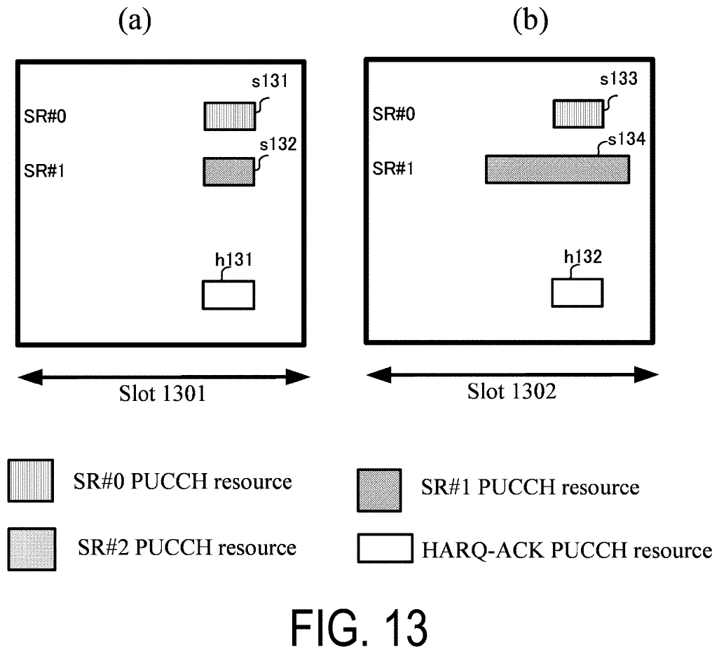

FIG. 13 is a diagram illustrating another example of transmitting a HARQ-ACK and a scheduling request using the PUCCH format 0, according to the present embodiment. In FIG. 13, the HARQ-ACK PUCCH resource for HARQ-ACK transmission overlaps with more than one SR PUCCH resource in the time domain.

In FIG. 13(a), in a slot 1301, the SR #0 has an SR PUCCH resource s131. In the slot 1301, the SR #1 has an SR PUCCH resource s132. A resource h131 is a HARQ-ACK PUCCH resource in the slot 1301. Here, the SR PUCCH resource s131 may be a resource that uses the PUCCH format 0 by a configuration of a higher layer parameter. The SR PUCCH resource s132 may be a resource that uses the PUCCH format 0 by a configuration of a higher layer parameter. The HARQ-ACK resource h131 may be a resource that uses the PUCCH format 0 at least based on the PUCCH resource indicator field included in the DCI format 1_0 or the DCI format 1_1 detected from the PDCCH. In FIG. 13(a), the HARQ-ACK PUCCH resource h131 overlaps with the SR PUCCH resource s131 in the time domain. The HARQ-ACK PUCCH resource h131 may have the same first symbol as the SR PUCCH resource s131. The HARQ-ACK PUCCH resource h131 overlaps with the SR PUCCH resource s132 in the time domain. The HARQ-ACK PUCCH resource h131 may have the same first symbol as the SR PUCCH resource s132. That is, the HARQ-ACK PUCCH resource overlaps with two SR PUCCH resources in the time domain.

In FIG. 13(a), in a case that the terminal apparatus 1 transmits the HARQ-ACK and a negative scheduling request, the terminal apparatus 1 may transmit the HARQ-ACK by using the PUCCH format 0 in the HARQ-ACK PUCCH resource h131. In a case that the terminal apparatus 1 transmits the HARQ-ACK and a positive scheduling request, the terminal apparatus 1 may transmit the HARQ-ACK and the positive scheduling by using the PUCCH format 0 in the SR PUCCH resource. Here, the transmission of the HARQ-ACK and the positive scheduling request performed by any of the SR PUCCH resource s131 and the SR PUCCH resource s132 may be indicated based on the indication of the MAC layer. For example, in a case that a scheduling request is triggered for the SR #0, the MAC layer may indicate to the physical layer to transmit the positive scheduling request by the SR PUCCH resource s131. The physical layer may transmit the HARQ-ACK and the positive scheduling request by using the PUCCH format 0 in the notified SR PUCCH resource s131. In this case, m_{cs} used to calculate a value of the cyclic shift a used in a sequence for the PUCCH format 0 may be given based on the value of the HARQ-ACK with reference to FIGS. 11(A) and (B). An initial value m₀ may be indicated from the higher layer parameter that has configured the SR PUCCH resource s131.

The base station apparatus 3 identifies for which scheduling request configuration a scheduling request has been transmitted based on by which SR PUCCH resource the HARQ-ACK having been detected.

In FIG. 13(b), in a slot 1302, the SR #0 has an SR PUCCH resource s133. In the slot 1302, the SR #1 has an SR PUCCH resource s134. A resource h132 is a HARQ-ACK PUCCH resource in the slot 1302. Here, the SR PUCCH resource s133 may be a resource that uses the PUCCH format 0 by a configuration of a higher layer parameter. The SR PUCCH resource s134 may be a resource that uses the PUCCH format 1 by a configuration of a higher layer parameter. The HARQ-ACK resource h132 may be a resource that uses the PUCCH format 0 at least based on the PUCCH resource indicator field included in the DCI format 1_0 or the DCI format 1_1 detected from the PDCCH. In FIG. 13(b), the HARQ-ACK PUCCH resource h132 overlaps with the SR PUCCH resource s133 in the time domain. The HARQ-ACK PUCCH resource h132 may have the same first symbol as the SR PUCCH resource s131. The HARQ-ACK PUCCH resource h132 overlaps with the SR PUCCH resource s134 in the time domain. The HARQ-ACK PUCCH resource h132 may not have the same first symbol as the SR PUCCH resource s134. That is, the HARQ-ACK PUCCH resource overlaps with two SR PUCCH resources in the time domain.

In FIG. 13(b), in a case that the terminal apparatus 1 transmits the HARQ-ACK and a negative scheduling request, the terminal apparatus 1 may transmit the HARQ-ACK by using the PUCCH format 0 in the HARQ-ACK PUCCH resource h132. In a case that the terminal apparatus 1 transmits the HARQ-ACK and a positive scheduling request, the terminal apparatus 1 may transmit the HARQ-ACK and the positive scheduling by using the PUCCH format 0 in the SR PUCCH resource. Here, the transmission of the HARQ-ACK and the positive scheduling request performed by any of the SR PUCCH resource s133 and the SR PUCCH resource s134 may be indicated based on the indication of the MAC layer. For example, in a case that a scheduling request is triggered for the SR #1, the MAC layer may indicate to the physical layer to transmit the positive scheduling request by the SR PUCCH resource s134. The physical layer may transmit the HARQ-ACK and the positive scheduling request by using the PUCCH format 1 in the notified SR PUCCH resource s134. Furthermore, in this case, the physical layer may transmit the HARQ-ACK and the positive scheduling request by using the PUCCH format 0 in the HARQ-ACK PUCCH resource h132. Additionally, m_{cs} used to calculate a value of the cyclic shift a used in a sequence for the PUCCH format 0 may be given based on the value of the HARQ-ACK with reference to FIGS. 11(C) and (D). An initial value m₀ may be indicated from the higher layer parameter that has configured the HARQ-ACK PUCCH resource h132.

Furthermore, for example, in FIG. 13(b), in a case that a scheduling request is triggered for the SR #0, the MAC layer may indicate to the physical layer to transmit the positive scheduling request by the SR PUCCH resource s133. The physical layer may transmit the HARQ-ACK and the positive scheduling request by using the PUCCH format 0 in the notified SR PUCCH resource s133. In this case, m_{cs} used to calculate a value of the cyclic shift a used in a sequence for the PUCCH format 0 may be given based on the value of the HARQ-ACK with reference to FIGS. 11(A) and (B). An initial value m₀ may be indicated from the higher layer parameter that has configured the SR PUCCH resource s133.

In the present embodiment, in a case that the terminal apparatus 1 transmits the HARQ-ACK and a negative scheduling request by using the PUCCH format 0, the terminal apparatus 1 may transmit the HARQ-ACK by using the PUCCH format 0 by the HARQ-ACK PUCCH resource, regardless of the number of SR PUCCH resources that have overlapped with the PUCCH resource for HARQ-ACK transmission in the time domain.

Furthermore, in a case that the terminal apparatus 1 transmits the HARQ-ACK and a positive scheduling request by using the PUCCH format 0, the terminal apparatus 1 may determine either the HARQ-ACK PUCCH resource or the SR PUCCH resource based on the number of SR PUCCH resources that have overlapped with the PUCCH resource for HARQ-ACK transmission in the time domain, and transmit the HARQ-ACK and the positive scheduling request by using the PUCCH format 0 by the determined PUCCH resource. In a case that the number of SR PUCCH resources that have overlapped with the PUCCH resource for HARQ-ACK transmission in the time domain is one, the terminal apparatus 1 may transmit the HARQ-ACK and the positive scheduling request by using the PUCCH format 0 by the PUCCH resource for HARQ-ACK transmission. In a case that the number of SR PUCCH resources that have overlapped with the PUCCH resource for HARQ-ACK transmission in the time domain is greater than one, the terminal apparatus 1 may transmit the HARQ-ACK and the positive scheduling request by using the PUCCH format 0 by an SR PUCCH resource notified from the MAC layer (higher layer).

That is, in a case that the terminal apparatus 1 transmits the HARQ-ACK and a positive scheduling request by using the PUCCH format 0, in a case that transmitting the PUCCH for one scheduling request transmission occasion (SR transmission occasion) that has overlapped with the PUCCH resource for HARQ-ACK transmission is configured, the terminal apparatus 1 may transmit the HARQ-ACK and the positive scheduling request by using the PUCCH format 0 by the PUCCH resource for HARQ-ACK transmission. Furthermore, in a case that the terminal apparatus 1 transmits the HARQ-ACK and a positive scheduling request by using the PUCCH format 0, in a case that transmitting the PUCCH for more than one scheduling request transmission occasion (SR transmission occasion) that has overlapped with the PUCCH resource for HARQ-ACK transmission is configured, the terminal apparatus 1 may transmit the HARQ-ACK and the positive scheduling request by using the PUCCH format 0 by the PUCCH resource for scheduling request transmission. The PUCCH resource for the scheduling request transmission may also be notified from the MAC layer (higher layer).

Furthermore, in a case that the terminal apparatus 1 transmits the HARQ-ACK and a positive scheduling request by using the PUCCH format 0, the terminal apparatus 1 may determine either the HARQ-ACK PUCCH resource or the SR PUCCH resource based on the number of SR PUCCH resources that have overlapped with the PUCCH resource for HARQ-ACK transmission in the time domain, and transmit the HARQ-ACK and the positive scheduling request by using the PUCCH format 0 by the determined PUCCH resource. In a case that the number of SR PUCCH resources that have overlapped with the PUCCH resource for HARQ-ACK transmission in the time domain is equal to N or smaller than N, the terminal apparatus 1 may transmit the HARQ-ACK and the positive scheduling request by using the PUCCH format 0 by the PUCCH resource for HARQ-ACK transmission. In a case that the number of SR PUCCH resources that have overlapped with the PUCCH resource for HARQ-ACK transmission in the time domain is greater than N, the terminal apparatus 1 may transmit the HARQ-ACK and the positive scheduling request by using the PUCCH format 0 by the SR PUCCH resource notified from the MAC layer (higher layer). The value of N may be given at least based on the number of bits of the HARQ-ACK to be transmitted. For example, in a case that the number of bits of the HARQ-ACK is one bit, N may be 5. In a case that the number of bits of the HARQ-ACK is two bits, N may be 2.

The number of UCI bits may be given at least based on the number of SR PUCCH resources that overlaps with the HARQ-ACK PUCCH resource in the time domain. The number of scheduling request bits may be given at least based on the number of SR PUCCH resources that overlaps with the HARQ-ACK PUCCH resource in the time domain. For example, in a case that N_{SR_O} SR PUCCH resources overlap with the HARQ-ACK PUCCH resource in the time domain, the number L of scheduling request bits may be Ceiling(log₂ (N_{SR_O}+1)). The scheduling request bits may be used to indicate the scheduling request configuration corresponding to each of the N_{SR_O} SR PUCCH resources and/or any of the negative SRs.

In a case that the HARQ-ACK PUCCH resource overlaps with one SR PUCCH resource in the time domain, regardless of whether or not a scheduling request for the one SR PUCCH resource is a negative scheduling request, the number of UCI bits may be given regardless of the more than one SR PUCCH resource.

In a case that the HARQ-ACK PUCCH resource overlaps with more than one SR PUCCH resource in the time domain, and in a case that a scheduling request for each of the overlapped SR PUCCH resources is a negative scheduling request, the number of UCI bits may be given regardless of the more than one SR PUCCH resource. In this case, the terminal apparatus 1 may determine a PUCCH resource set regardless of SR bits.

In a case that the HARQ-ACK resource overlaps with more than one SR PUCCH resource in the time domain, and in a case that a scheduling request for at least one SR PUCCH resource among the overlapped SR PUCCH resources is a positive scheduling request, the number of UCI bits may be given at least based on the number of SR PUCCH resources more than one. In other words, in this case, the terminal apparatus 1 may select a PUCCH resource set based on the given number of UCI bits.

As another example according to the present embodiment, in a case that the terminal apparatus 1 transmits one or two-bit HARQ-ACK by using the PUCCH format 0, in a case that the HARQ-ACK resource overlaps with more than one SR PUCCH resource in the time domain and in a case that the scheduling request for at least one SR PUCCH resource among the overlapped SR PUCCH resources is a positive scheduling request, the terminal apparatus 1 may transmit the HARQ-ACK and the positive scheduling request by using the PUCCH format 2 (or a PUCCH format corresponding to any of PUCCH resources included in the second PUCCH resource set), by the HARQ-ACK PUCCH resource. The HARQ-ACK PUCCH resource may be given at least based on the PUCCH resource indicator field included in the DCI format 1_0 or the DCI format 1_1 detected from the PDCCH. In this case, the first determination method and/or the second determination method as described above may be used. The HARQ-ACK PUCCH resource may be given from the second PUCCH resource set at least based on the PUCCH resource indicator field included in the DCI format 1_0 or the DCI format 1_1 detected from the PDCCH. In this case, the first determination method and/or the second determination method as described above may be used.

A configuration of the terminal apparatus 1 of the present invention will be described below.

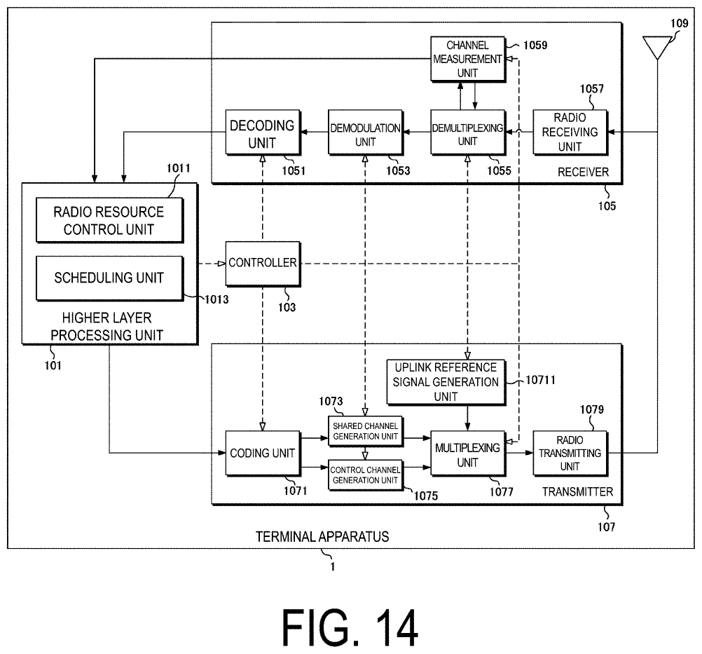

FIG. 14 is a schematic block diagram illustrating a configuration of the terminal apparatus 1 according to the present embodiment. As illustrated, the terminal apparatus 1 is configured to include at least one of a higher layer processing unit 101, a controller 103, a receiver 105, a transmitter 107, and a transmit and receive antenna 109. The higher layer processing unit 101 is configured to include at least one of a radio resource control unit 1011 and a scheduling unit 1013. The receiver 105 is configured to include at least one of a decoding unit 1051, a demodulation unit 1053, a demultiplexing unit 1055, a radio receiving unit 1057, and a channel measurement unit 1059. The transmitter 107 is configured to include at least one of a coding unit 1071, a shared channel generation unit 1073, a control channel generation unit 1075, a multiplexing unit 1077, a radio transmitting unit 1079, and an uplink reference signal generation unit 10711.

The higher layer processing unit 101 outputs uplink data generated through a user operation or the like to the transmitter 107. The higher layer processing unit 101 performs processing of the Medium Access Control (MAC) layer, the Packet Data Convergence Protocol (PDCP) layer, the Radio Link Control (RLC) layer, and the Radio Resource Control (RRC) layer. Furthermore, the higher layer processing unit 101 generates control information for control of the receiver 105 and the transmitter 107 based on downlink control information or the like received on a control channel and outputs the generated control information to the controller 103.

The radio resource control unit 1011 included in the higher layer processing unit 101 manages various kinds of configuration information of the terminal apparatus 1. For example, the radio resource control unit 1011 manages a configured serving cell. Furthermore, the radio resource control unit 1011 generates information to be mapped to each uplink channel, and outputs the generated information to the transmitter 107. In a case that the received downlink data is successfully decoded, the radio resource control unit 1011 generates an ACK and outputs the ACK to the transmitter 107, and in a case that decoding of the received downlink data is failed, the radio resource control unit 1011 generates a NACK and outputs the NACK to the transmitter 107.

The scheduling unit 1013 included in the higher layer processing unit 101 stores downlink control information received via the receiver 105. The scheduling unit 1013 controls the transmitter 107 via the controller 103 so as to transmit a PUSCH according to a received uplink grant in the fourth subsequent subframe from the subframe in which the uplink grant has been received. The scheduling unit 1013 controls the receiver 105 via the controller 103 so as to receive a shared channel according to a received downlink grant in the subframe in which the downlink grant has been received.

The controller 103 generates a control signal for control of the receiver 105 and the transmitter 107 based on the control information from the higher layer processing unit 101. The controller 103 outputs the generated control signal to the receiver 105 and the transmitter 107 to control the receiver 105 and the transmitter 107.

In accordance with the control signal input from the controller 103, the receiver 105 demultiplexes, demodulates, and decodes a reception signal received from the base station apparatus 3 through the transmit and receive antenna 109, and outputs information resulting from the decoding to the higher layer processing unit 101.

The radio receiving unit 1057 orthogonally demodulates a downlink signal received via the transmit and receive antenna 109, and converts the orthogonally-demodulated analog signal to a digital signal. The radio receiving unit 1057, for example, may perform Fast Fourier Transform (FFT) on the digital signal and extract a signal of the frequency domain.

The demultiplexing unit 1055 demultiplexes the extracted signals into a control channel, a shared channel, and a reference signal channel, respectively. The demultiplexing unit 1055 outputs the separated reference signal channel to the channel measurement unit 1059.

The demodulation unit 1053 demodulates the control channel and the shared channel by using a modulation scheme such as QPSK, 16 Quadrature Amplitude Modulation (QAM), 64 QAM, and the like, and outputs the result of the demodulation to the decoding unit 1051.

The decoding unit 1051 decodes the downlink data and outputs, to the higher layer processing unit 101, the decoded downlink data. The channel measurement unit 1059 calculates a downlink channel estimate from the reference signal channel and outputs the calculation result to the demultiplexing unit 1055. The channel measurement unit 1059 calculates channel state information and outputs the channel state information to the higher layer processing unit 101.

The transmitter 107 generates an uplink reference signal channel in accordance with the control signal input from the controller 103, encodes and modulates the uplink data and uplink control information input from the higher layer processing unit 101, multiplexes the shared channel, the control channel, and the reference signal channel, and transmits a signal resulting from the multiplexing to the base station apparatus 3 through the transmit and receive antenna 109.

The coding unit 1071 encodes the uplink control information and uplink data input from the higher layer processing unit 101 and outputs the coded bits to the shared channel generation unit 1073 and/or the control channel generation unit 1075.

The shared channel generation unit 1073 may modulate the coded bits input from the coding unit 1071 to generate a modulation symbol, generate the shared channel by performing DFT on the modulation symbol and output the shared channel to the multiplexing unit 1077. The shared channel generation unit 1073 may modulate the coded bits input from the coding unit 1071 to generate a shared channel and output the shared channel to the multiplexing unit 1077.

The control channel generation unit 1075 generates a control channel based on the coded bits input from the coding unit 1071 and/or SR and outputs the generated control channel to the multiplexing unit 1077.

The uplink reference signal generation unit 10711 generates an uplink reference signal and outputs the generated uplink reference signal to the multiplexing unit 1077.

The multiplexing unit 1077 multiplexes a signal input from the shared channel generation unit 1073 and/or a signal input from the control channel generation unit 1075 and/or the uplink reference signal input from the uplink reference signal generation unit 10711 into an uplink resource element for each transmit antenna port according to the control signal input from the controller 103.

The radio transmitting unit 1079 performs Inverse Fast Fourier Transform (IFFT) on the multiplexed signal, generates a baseband digital signal, converts the baseband digital signal into an analog signal, generates an in-phase component and an orthogonal component of an intermediate frequency from the analog signal, removes frequency components unnecessary for the intermediate frequency band, converts (up-converts) the signal of the intermediate frequency into a signal of a high frequency, removes unnecessary frequency components, performs power amplification, and outputs a final result to the transmit and receive antenna 109 for transmission.

A configuration of the base station apparatus 3 of the present invention will be described below.

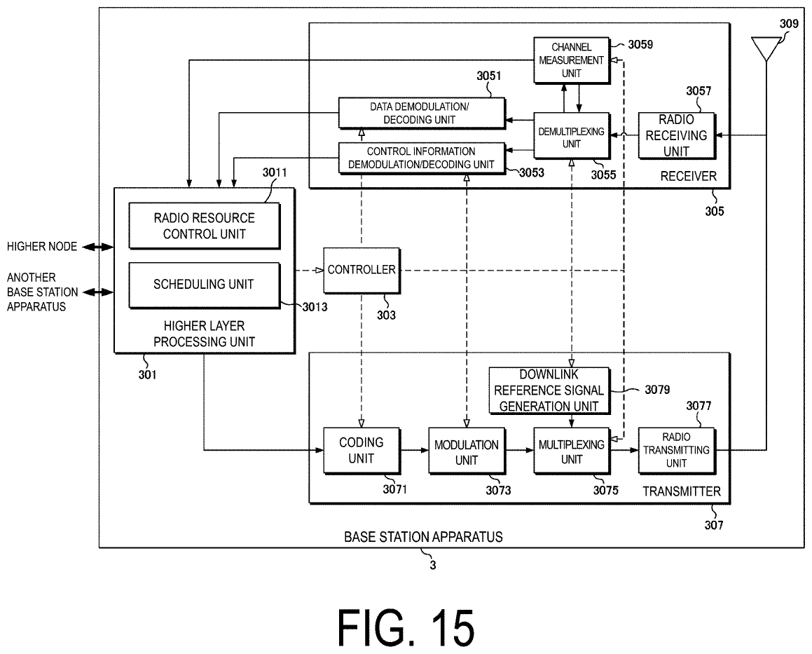

FIG. 15 is a schematic block diagram illustrating a configuration of the base station apparatus 3 according to the present embodiment. As is illustrated, the base station apparatus 3 is configured to include a higher layer processing unit 301, a controller 303, a receiver 305, a transmitter 307, and a transmit and receive antenna 309. Furthermore, the higher layer processing unit 301 is configured to include a radio resource control unit 3011 and a scheduling unit 3013. Furthermore, the receiver 305 is configured to include a data demodulation/decoding unit 3051, a control information demodulation/decoding unit 3053, a demultiplexing unit 3055, a radio receiving unit 3057, and a channel measurement unit 3059. The transmitter 307 is configured to include a coding unit 3071, a modulation unit 3073, a multiplexing unit 3075, a radio transmitting unit 3077, and a downlink reference signal generation unit 3079.

The higher layer processing unit 301 performs processing of the Medium Access Control (MAC) layer, the Packet Data Convergence Protocol (PDCP) layer, the Radio Link Control (RLC) layer, and the Radio Resource Control (RRC) layer. Furthermore, the higher layer processing unit 301 generates control information for control of the receiver 305 and the transmitter 307, and outputs the generated control information to the controller 303.

The radio resource control unit 3011 included in the higher layer processing unit 301 generates or acquires from a higher node, downlink data mapped to a shared channel of downlink, RRC signaling, and a MAC Control Element (CE), and outputs the downlink data, the RRC signaling, and the MAC CE to the HARQ controller 3013. Furthermore, the radio resource control unit 3011 manages various configuration information for each of the terminal apparatuses 1. For example, the radio resource control unit 3011 manages a serving cell configured for the terminal apparatus 1, and the like.

The scheduling unit 3013 included in the higher layer processing unit 301 manages radio resources of shared channels and control channels allocated to the terminal apparatus 1. In a case that a radio resource of the shared channel is allocated to the terminal apparatus 1, the scheduling unit 3013 generates an uplink grant indicating the allocation of the radio resource of the shared channel and outputs the generated uplink grant to the transmitter 307.

The controller 303 generates a control signal for controlling the receiver 305 and the transmitter 307 based on the control information from the higher layer processing unit 301. The controller 303 outputs the generated control signal to the receiver 305 and the transmitter 307 to control the receiver 305 and the transmitter 307.

In accordance with the control signal input from the controller 303, the receiver 305 demultiplexes, demodulates, and decodes a reception signal received from the terminal apparatus 1 through the transmit and receive antenna 309, and outputs information resulting from the decoding to the higher layer processing unit 301.

The radio receiving unit 3057 orthogonally demodulates the uplink signal received via the transmit and receive antenna 309 and converts the orthogonally-demodulated analog signal into a digital signal. The radio receiving unit 3057 performs Fast Fourier Transform (FFT) on the digital signal, extracts a signal of the frequency domain, and outputs the resulting signal to the demultiplexing unit 3055.

The demultiplexing unit 1055 demultiplexes the signal input from the radio receiving unit 3057 into signals of the control channel, the shared channel, the reference signal channel, and the like. The demultiplexing is performed based on radio resource allocation information that is determined in advance by the base station apparatus 3 using the radio resource control unit 3011 and that is included in the uplink grant notified to each of the terminal apparatuses 1. The demultiplexing unit 3055 performs channel compensation for the control channel and the shared channel from the channel estimate input from the channel measurement unit 3059. Furthermore, the demultiplexing unit 3055 outputs the demultiplexed reference signal channel to the channel measurement unit 3059.

The demultiplexing unit 3055 acquires a modulation symbol of the uplink data and a modulation symbol of the uplink control information (HARQ-ACK) from the control channel and the shared channel that are demultiplexed. The demultiplexing unit 3055 outputs the modulation symbol of the uplink data acquired from the shared channel signal to the data demodulation/decoding unit 3051. The demultiplexing unit 3055 outputs the modulation symbol of the uplink control information (HARQ-ACK) acquired from the control channel or the shared channel to the control information demodulation/decoding unit 3053.

The channel measurement unit 3059 measures the channel estimate, the channel quality, and the like, based on the uplink reference signal input from the demultiplexing unit 3055 and outputs the measurement result to the demultiplexing unit 3055 and the higher layer processing unit 301.

The data demodulation/decoding unit 3051 decodes the uplink data from the modulation symbol of the uplink data input from the demultiplexing unit 3055. The data demodulation/decoding unit 3051 outputs the decoded uplink data to the higher layer processing unit 301.

The control information demodulation/decoding unit 3053 decodes the HARQ-ACK from the modulation symbol of the HARQ-ACK input from the demultiplexing unit 3055. The control information demodulation/decoding unit 3053 outputs the decoded HARQ-ACK to the higher layer processing unit 301.

The transmitter 307 generates the downlink reference signal according to the control signal input from the controller 303, encodes and modulates the downlink control information and the downlink data that are input from the higher layer processing unit 301, multiplexes the control channel, the shared channel, and the reference signal channel, and transmits a signal resulting from the multiplexing to the terminal apparatus 1 through the transmit and receive antenna 309.

The coding unit 3071 encodes the downlink control information and the downlink data input from the higher layer processing unit 301. The modulation unit 3073 modulates the coded bits input from the coding unit 3071, in compliance with the modulation scheme such as BPSK, QPSK, 16 QAM, or 64 QAM. The modulation unit 3073 may apply precoding to the modulation symbol. The precoding may include a transmission precode. Note that precoding may be a multiplication (application) of a precoder.

The downlink reference signal generation unit 3079 generates a downlink reference signal. The multiplexing unit 3075 multiplexes the modulation symbol of each channel and the downlink reference signal and generates the transmission symbol.

The multiplexing unit 3075 may apply precoding to the transmission symbol. The precoding that the multiplexing unit 3075 applies to the transmission symbol may be applied to the downlink reference signal and/or the modulation symbol. The precoding applied to the downlink reference signal and the precoding applied to the modulation symbol may be the same or different.

The radio transmitting unit 3077 performs Inverse Fast Fourier Transform (IFFT) on the multiplexed transmission symbol and the like to generate a time symbol. The radio transmitting unit 3077 modulates the time symbol in compliance with an OFDM scheme, generates a baseband digital signal, converts the baseband digital signal into an analog signal, generates an in-phase component and an orthogonal component of an intermediate frequency from the analog signal, removes frequency components unnecessary for the intermediate frequency band, converts (up-converts) the signal of the intermediate frequency into a signal of a high frequency, removes unnecessary frequency components, and generates a carrier signal (carrier, RF signal, or the like). The radio transmitting unit 3077 performs power amplification on the carrier signal and outputs the amplified signal to the transmit and receive antenna 309 for transmission.

Hereinafter, various aspects of the terminal apparatus and the base station apparatus in the present embodiment will be described.

(1) To accomplish the object described above, aspects of the present invention are contrived to provide the following measures. That is, a first aspect of the present invention is a terminal apparatus, the terminal apparatus including: a receiver 105 configured to receive higher layer signaling used for configuration of multiple scheduling request configurations; and a transmitter 107 configured to transmit HARQ-ACK and a scheduling request by using a PUCCH format 0 by a HARQ-ACK PUCCH resource or an SR PUCCH resource, in which one or more than one logical channel corresponds to each of the scheduling request configurations, each of the multiple scheduling request configurations has the SR PUCCH resource, in a case that the HARQ-ACK resource overlaps with one or multiple SR PUCCH resources in the time domain, and the HARQ-ACK and the scheduling request are transmitted, and the scheduling request is a positive scheduling request, and a PUCCH format of the HARQ-ACK PUCCH resource for HARQ-ACK transmission is the PUCCH format 0, based on the number of SR PUCCH resources that have overlapped, the HARQ-ACK PUCCH resource or the SR PUCCH resource is selected, and the HARQ-ACK and the positive scheduling request are transmitted by the selected resource.

(2) Furthermore, in the first aspect of the present invention, in a case that the number of SR PUCCH resources that have overlapped with the HARQ-ACK PUCCH resource in the time domain is one, the HARQ-ACK and the positive scheduling request are transmitted by using the PUCCH format 0 by the HARQ-ACK PUCCH resource, and in a case that the number of SR PUCCH resources that have overlapped with the HARQ-ACK PUCCH resource in the time domain is greater than one, the HARQ-ACK and the positive scheduling request are transmitted by using the PUCCH format 0 by the SR PUCCH resource.

(3) Furthermore, in the first aspect of the present invention, in a case that the number of SR PUCCH resources that have overlapped with the HARQ-ACK PUCCH resource in the time domain is greater than one, among the multiple SR PUCCH resources, an SR PUCCH resource used to transmit the HARQ-ACK and the positive scheduling request is indicated from a MAC layer.

(4) Furthermore, a second aspect of the present invention is a base station apparatus, the base station apparatus includes: a transmitter 307 configured to transmit higher layer signaling used for configuration of multiple scheduling request configurations; and a receiver 305 configured to receive HARQ-ACK and a scheduling request by using a PUCCH format 0 by a HARQ-ACK PUCCH resource or an SR PUCCH resource, in which one or more than one logical channel corresponds to each of the scheduling request configurations, each of the multiple scheduling request configurations has the SR PUCCH resource, in a case that the HARQ-ACK resource overlaps with one or multiple SR PUCCH resources in the time domain, and the HARQ-ACK and the scheduling request are transmitted, and the scheduling request is a positive scheduling request, and a PUCCH format of the HARQ-ACK PUCCH resource for HARQ-ACK transmission is the PUCCH format 0, based on the number of SR PUCCH resources that have overlapped, the HARQ-ACK PUCCH resource or the SR PUCCH resource is selected, and the HARQ-ACK and the positive scheduling request are received by the selected resource.

(5) Furthermore, in the second aspect of the present invention, in a case that the number of SR PUCCH resources that have overlapped with the HARQ-ACK PUCCH resource in the time domain is one, the HARQ-ACK and the positive scheduling request are received by using the PUCCH format 0 by the HARQ-ACK PUCCH resource, and in a case that the number of SR PUCCH resources that have overlapped with the HARQ-ACK PUCCH resource in the time domain is greater than one, the HARQ-ACK and the positive scheduling request are received by using the PUCCH format 0 by the SR PUCCH resource.

(6) Furthermore, in the second aspect of the present invention, in a case that the number of SR PUCCH resources that have overlapped with the HARQ-ACK PUCCH resource in the time domain is greater than one, among the multiple SR PUCCH resources, an SR PUCCH resource used to transmit the HARQ-ACK and the positive scheduling request is indicated from a MAC layer.

A program running on the terminal apparatus 1 and the base station apparatus 3 according to the present invention may be a program that controls a central processing unit (CPU) and the like (a program causing a computer to function) in such a manner as to realize the functions of the above-described embodiment according to the present invention. The information handled in these devices is temporarily stored in a Random Access Memory (RAM) while being processed. Thereafter, the information is stored in various types of Read Only Memory (ROM) such as a Flash ROM and a Hard Disk Drive (HDD), and when necessary, is read out by the CPU to be modified or rewritten.

Note that the terminal apparatus 1 and the base station apparatus 3 according to the above-described embodiment may be partially achieved by a computer. In that case, this configuration may be realized by recording a program for realizing such control functions on a computer-readable recording medium and causing a computer system to read the program recorded on the recording medium for execution.

Note that it is assumed that a “computer system” mentioned here refers to a computer system built into the terminal apparatus 1 or the base station apparatus 3, and the computer system includes an OS and hardware components such as a peripheral apparatus. Furthermore, a “computer-readable recording medium” refers to a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. Furthermore, the above-described program may be one for realizing some of the above-described functions, and also may be one capable of realizing the above-described functions in combination with a program already recorded in a computer system.

Furthermore, the terminal apparatus 1 and the base station apparatus 3 according to the above-described embodiment may be achieved as an aggregation (apparatus group) including multiple apparatuses. Each of the apparatuses constituting such an apparatus group may include at least one of respective functions or functional blocks of the terminal apparatus 1 and the base station apparatus 3 according to the above-described embodiment. The apparatus group needs to have a complete set of functions or functional blocks of the terminal apparatus 1 and the base station apparatus 3. Furthermore, the terminal apparatus 1 and the base station apparatus 3 according to the above-described embodiment can also communicate with a base station apparatus as an aggregation.

Furthermore, the base station apparatus 3 according to the above-described embodiment may serve as an Evolved Universal Terrestrial Radio Access Network (EUTRAN). Furthermore, the base station apparatus 3 according to the above-described embodiment may have at least one of the functions of a node higher than an eNodeB.

Furthermore, some or all portions of each of the terminal apparatus 1 and the base station apparatus 3 according to the above-described embodiment may be typically achieved as an LSI which is an integrated circuit or may be achieved as a chip set. The functional blocks of each of the terminal apparatus 1 and the base station apparatus 3 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use a new integrated circuit based on the technology according to one or multiple aspects of the present invention.

Furthermore, according to the above-described embodiment, the terminal apparatus has been described as an example of a communication apparatus, but the present invention is not limited to such a terminal apparatus, and is applicable to a terminal apparatus or a communication apparatus of a fixed-type or a stationary-type electronic apparatus installed indoors or outdoors, for example, such as an Audio-Video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

1-8. (canceled)

9. A terminal apparatus comprising:
a receiver configured to receive higher layer signaling used for configuration of a HARQ-ACK PUCCH resource or a scheduling request (SR) PUCCH resource; and
a transmitter configured to transmit a HARQ-ACK bit in a HARQ-ACK PUCCH resource using PUCCH format 1 and to transmit scheduling request in a SR PUCCH resource using PUCCH format 0,
in a case that the HARQ-ACK PUCCH resource overlaps with the SR PUCCH resource in a time domain, to transmit the HARQ-ACK bit in the HARQ-ACK PUCCH resource using PUCCH format 1, wherein the scheduling request is either a negative scheduling request or a positive scheduling request.

10. The terminal apparatus according to claim 9,
wherein the PUCCH format 0 corresponds to transmission of Uplink control information (UCI) bits having a maximum of two bits and is transmitted by one or two symbols, and
the PUCCH format 1 corresponds to transmission of UCI bits having a maximum of two bits, and is transmitted by four symbols or more than four symbols.

11. A base station apparatus comprising:
a transmitter configured to transmit higher layer signaling used for configuration of a HARQ-ACK PUCCH resource or a scheduling request (SR) PUCCH resource; and
a receiver configured to receive a HARQ-ACK bit in a HARQ-ACK PUCCH resource using PUCCH format 1 and to receive scheduling request in a SR PUCCH resource using PUCCH format 0,
in a case that the HARQ-ACK PUCCH resource overlaps with the SR PUCCH resource in a time domain, to receive the HARQ-ACK bit in the HARQ-ACK PUCCH resource using PUCCH format 1, wherein the scheduling request is either a negative scheduling or a positive scheduling request.

12. The base station apparatus according to claim 11,
wherein the PUCCH format 0 corresponds to transmission of Uplink control information (UCI) bits having a maximum of two bits and is transmitted by one or two symbols,
the PUCCH format 1 corresponds to transmission of UCI bits having a maximum of two bits, and is transmitted by four symbols or more than four symbols.

13. A communication method of a terminal apparatus, the communication method comprising:
receiving higher layer signaling used for configuration of a HARQ-ACK PUCCH resource or a scheduling request (SR) PUCCH resource; and
transmitting a HARQ-ACK bit in a HARQ-ACK PUCCH resource using PUCCH format 1 and transmitting scheduling request in a SR PUCCH resource using PUCCH format 0,
in a case that the HARQ-ACK PUCCH resource overlaps with the SR PUCCH resource in a time domain, transmitting the HARQ-ACK bit in the HARQ-ACK PUCCH resource using PUCCH format 1, wherein the scheduling request is either a negative scheduling request or a positive scheduling request.

14. The communication method according to claim 13,
wherein the PUCCH format 0 corresponds to transmission of Uplink control information (UCI) bits having a maximum of two bits and is transmitted by one or two symbols,
the PUCCH format 1 corresponds to transmission of UCI bits having a maximum of two bits, and is transmitted by four symbols or more than four symbols.

15. A communication method of a base station apparatus, the communication method comprising:
transmitting higher layer signaling used for configuration of a HARQ-ACK PUCCH resource or a scheduling request (SR) PUCCH resource; and
receiving a HARQ-ACK bit in a HARQ-ACK PUCCH resource using PUCCH format 1 and,
receiving scheduling request in a SR PUCCH resource using PUCCH format 0,
in a case that the HARQ-ACK PUCCH resource overlaps with the SR PUCCH resource in a time domain, to receive the HARQ-ACK bit in the HARQ-ACK PUCCH resource using PUCCH format 1, wherein the scheduling request is either a negative scheduling or a positive scheduling request.

16. The communication method according to claim 15,
wherein the PUCCH format 0 corresponds to transmission of Uplink control information (UCI) bits having a maximum of two bits and is transmitted by one or two symbols,
the PUCCH format 1 corresponds to transmission of UCI bits having a maximum of two bits, and is transmitted by four symbols or more than four symbols.
